(19) United States
(12) Patent Application Publication
(10) Pub. No.: US 2024/0403745 A1
(43) Pub. Date: Dec. 5, 2024

(54) SYSTEMS, MEDIA, AND METHODS FOR ADAPTIVE EXPERIMENTATION MODELING

(71) Applicant: 3M INNOVATIVE PROPERTIES COMPANY, St. Paul, MN (US)

(72) Inventors: Frederick J. Arsenault, Stillwater, MN (US); Brian E. Brooks, St. Paul, MN (US); Sean T. Kalafut, Minneapolis, MN (US); Peter G. Klink, St. Paul, MN (US); Scott A. Ostercamp, Lakeville, MN (US); Tyler W. Olson, Esko, MN (US); Peter O.N. Olson, Andover, MN (US); Wilmina M. Marget, Rosemount, MN (US); Angela Reda, St. Paul, MN (US)

(21) Appl. No.: 18/698,149

(22) PCT Filed: Oct. 12, 2022
(86) PCT No.: PCT/US2022/046382

§ 371 Date: Apr. 3, 2024

Related U.S. Application Data
(60) Provisional application No. 63/255,314, filed on Oct. 13, 2021.
(60) Provisional application No. 63/415,049, filed on Oct. 11, 2022.

(51) Int. Cl. G06Q 10/0631

(52) U.S. Cl. CPC G06Q 10/0631

(57) ABSTRACT

A method includes selecting a plurality of operational components to which operational resources are allocated, selecting a plurality of control signals for the plurality of operational components, applying the plurality of control signals to the plurality of operational components to determine an operational effect of the plurality control signals on the operational components, applying a resource requirement for each of the plurality of operational components, determining, using a queue optimization model, a first control signal target value, based on the operational effect of each of the plurality of control signals on each of the plurality of operational components and the resource requirement for each of the plurality of control signals for each of the plurality of operational components, and assigning, based on the first control signal target value, an operational resource allocation to each of the plurality of operational components.

### BACKGROUND

Retailers expend significant resources to understand the assortment of their products, with attention given to many considerations. Considerations, such as (i) where products should be located within a planogram, (ii) where should products be located in the store, (iii) when should out-of-stock products should be replenished, and/or (iv) where temporary product planograms, like seasonal displays and endcaps, should be located in the store have historically been evaluated in ways that are error-prone and time-consuming. Entire teams can be targeted at each of these and other important questions, using constrained resources in attempts to haphazardly solve each issue based on a belief that solving one issue does not have a significant effect (beneficial or detrimental) on other issues.

### SUMMARY

In one embodiment, a method includes selecting a plurality of operational components to which operational resources are allocated, selecting a plurality of control signals for the plurality of operational components, applying the plurality of control signals to the plurality of operational components to determine an operational effect of the plurality control signals on the operational components, applying a resource requirement for each of the plurality of operational components, determining, using a queue optimization model, a first control signal target value, based on the operational effect of each of the plurality of control signals on each of the plurality of operational components and the resource requirement for each of the plurality of control signals for each of the plurality of operational components, and assigning, based on the first control signal target value, an operational resource allocation to each of the plurality of operational components.

In another embodiment, a computing device includes a memory and a processor, wherein the memory is coupled to the processor that is configured to select a plurality of operational components to which operational resources are allocated, select a plurality of control signals for the plurality of operational components, apply the plurality of control signals to the plurality of operational components to determine an operational effect of the plurality control signals on the operational components, apply a resource requirement for each of the plurality of operational components, determine, using a queue optimization model, a first control signal target value, based on the operational effect of each of the plurality of control signals on each of the plurality of operational components and the resource requirement for each of the plurality of control signals for each of the plurality of operational components, and assign, based on the first control signal target value, an operational resource allocation to each of the plurality of operational components.

In a further embodiment, one or more non-transitory computer-readable media are encoded with instructions that, when executed, configure processing circuitry of a computing device for selecting a plurality of operational components to which operational resources are allocated, selecting a plurality of control signals for the plurality of operational components, applying the plurality of control signals to the plurality of operational components to determine an operational effect of the plurality control signals on the operational components, applying a resource requirement for each of the plurality of operational components, determining, using a queue optimization model, a first control signal target value, based on the operational effect of each of the plurality of control signals on each of the plurality of operational components and the resource requirement for each of the plurality of control signals for each of the plurality of operational components, and assigning, based on the first control signal target value, an operational resource allocation to each of the plurality of operational components.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims.

FIG. 1 is a diagram schematically illustrating a system for controlled experimentation and modeling of operational resources in accordance with embodiments herein;

FIG. 2 is a flow diagram schematically illustrating a method for applying control signals to operational components to determine operational resource allocation in accordance with embodiments herein:

FIG. 3 is a flow diagram schematically depicting input data and various retail processes in accordance with embodiments herein:

FIG. 4 is a flow diagram schematically illustrating a method for optimizing item availability and assortment in accordance with embodiments herein:

FIG. 5 is a diagram schematically illustrating assortment optimization inputs and components in accordance with embodiments herein:

FIG. 6 is a graph depicting time period duration for in-stock and out-of-stock periods in accordance with embodiments herein:

FIG. 7 is a flow diagram schematically illustrating a method for optimizing retail planograms in accordance with embodiments herein; and

FIG. 8 is a block diagram of computing hardware utilized to implement various embodiments herein.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Successful operation of a retail facility (such as a store or market) can depend at least in part on optimizing the allocation of resources among the various operational components available to be resourced. Whether an item (or product, with the terms ‘item’ and ‘product’ being utilized interchangeably) on a shelf is out-of-stock can affect the overall store sales and customer satisfaction. When an item is out-of-stock on a shelf, it may be because no items are available in a store to put onto the shelf, it could be that the store operations do not currently have any available resources to restock the shelves for customers due to other competing priorities, or it may be that an item is available but in a location unexpected or unfamiliar to customers and is “effectively” out-of-stock.

The reason for this apparent out-of-stock affects what the correct action to be taken is. A store operations leader may need to adjust inventory or ordering, may need to assign someone to restock shelves, may need to change the in-store product location, or may need to change the planogram design. Furthermore, it may be that such out-of-stock instances are happening across the entire store, and that a store operations leader should decide which to fix, how, and when. In some embodiments, factors and/or decisions may be handled across multiple stores by regional or chain-wide people and teams. For example, changes to planogram design may not necessarily be handled only at a store level. All of this requires dynamic allocation of resources, whether they be capital (ordering more inventory), assigning people (restocking), and/or changing the layout of the store (in-store product location or planogram design).

Operational components discussed herein, by way of non-limiting example, relate to out-of-stock, assortment, in-store product location, planogram design, customer substitution behaviors, and purchase patterns. By out-of-stock, it generally relates in some embodiments to describing balancing which out-of-stock situations should and should not be fixed, the timing of when they should be fixed, and how such actions should be prioritized. By assortment, it generally relates in some embodiments to determining the mix of products offered at each store. By in-store product location, it generally relates in some embodiments to measuring and adjusting the placement of products at different locations within a store (e.g., in an aisle, which aisle, in an end-cap, location of the end-cap, at check-out, temporary or permanent, and the like). By planogram design, it generally relates in some embodiments to measuring and adjusting the placement of products relative to each other at a specific in-store location (e.g., for a given item, for instance, placing the item on the far left of the bottom shelf next to items A and B, placing the item in the center of the top shelf between items D and H, and the like). By customer substitution behaviors, it generally relates in some embodiments to how, when, and for what different customers will substitute purchase one or more items when another item(s) is/are out-of-stock or otherwise not available. By purchase patterns, it generally relates in some embodiments to multi-item purchase patterns, such as, for instance, customers who purchase hammers often also purchase nails on the same trip. However, the reverse may not hold true in some embodiments. For example, customers in search of nails will not necessarily purchase hammers if they already have them.

Embodiments herein may treat each of the operational components and their interrelationships as a queue optimization problem and experiment, whereby algorithmic models may direct adaptive randomized controlled trials on operational resource allocation both within and across operational components. The adaptive randomized controlled trials may explore and exploit the causal structure of the problem-spaces of each of a plurality of operational components, as well as the interrelationships between each of a plurality of operational components, and can help to determine the allocation of operational resources within and across each of the plurality of operational components to optimize operational goals like profit growth and reduced supply chain costs. Furthermore, some embodiments can improve the data quality acquired from retail operations, elucidating not only correlative relationships, but also causational relationships arising from resource allocation changes. To illustrate this, a non-limiting example includes two operational components, out-of-stock and in-store product location. If one takes a set of one hundred stores, all of which have hundreds of items for sale, focus may be placed on two specific items (“Grindy Widget” and “Sticky Widget”). Grindy Widget, in this example, can be placed at three different locations in the stores (e.g., in the planogram at aisle 3, at an endcap of aisle 6, and/or at the checkout line). Sticky Widget can be located in one of three locations also (i.e., in the planogram at aisle 7, at an endcap of aisle 2, and/or at a spindle at the entrance for this hypothetical), there are 8 location combinations in each case. Thus, Sticky Widget may be located at: location 1, but not 2 and 3; at location 2 but not 1 and 3; at location 3 but not 1 and 2; at location 1 and 2 but not 3; at location 2 and 3 but not 1; at location 1 and 3 but not 2; at all locations; at none of the locations).

As is common in retail operations, the availability of Grindy Widget (GW) and of Sticky Widget (SW) may change from “available” to “unavailable” for purchase at any particular point in time. This situation is sometimes referred to as out-of-stock. More specifically, GW and/or SW may be out-of-stock in a particular in-store product location, or at all locations across a store. Two retail goals may be particularly relevant to this situation, as a retailer may want to determine the business value of having GW and/or SW available at each of their candidate in-store product locations, and the retailer may also want to efficiently prioritize employee time in fixing out-of-stock instances (such as restocking shelves), when either GW, SW, or both are out-of-stock.

As to the first goal, this is one of the most critical decisions that a retailer, particularly a retailer in a physical “brick-and-mortar” store, may make in some embodiments, because space allocation in a brick-and-mortar retail operation may be a zero-sum situation. By contrast, an e-commerce retailer may not have the same zero-sum situation since there is not a physical store. When an item occupies a given space, it is not possible for a different item to occupy that given space. Thus, optimizing this zero-sum situation requires reliable and accurate data regarding the effects of changes of both in-stock status as well as product location (both separately and collectively).

Furthermore, it is crucial in some embodiments that store employees spend their time efficiently, as they may not be able to spend all of their time fixing out-of-stock instances. Accordingly, in some embodiments a retail operation needs to have accurate data regarding which out-of-stock instances receive resources for fixing and which can be addressed during a normal replenishing operation. This problem is obviously much more complex within the context of a retail operation having hundreds, thousands, or larger quantities of items, with a plurality of choices for in-store product location.

One traditional approach in retail to determine a course of action with regard to out-of-stock and in-store location decisions has been to follow a passive data observation coupled with statistical modeling, and responding to each of these considerations independently. For instance, an analyst might examine sales rates, profit margins, and other business indicators of each item being considered and create a statistical mathematical model that would then be used to generate predictions about the business impact of each item being out-of-stock. Then the model would prioritize the items with the highest predicted business impact to “fix” the out-of-stock first (versus second or normal course of business replenishment). Likewise, for in-store location optimization, an analyst might consider historical sales of items for stores that have the items located at different candidate locations.

There are several important limitations to these traditional approaches, however. These may include that they do not separate correlation from causation, they do not give any information about quality of or usability of historical data, they do not provide any insights into interdependencies of operations, they do not handle well the fact that historical observational data may be confounded, and they fail to handle well instances when customer behaviors in the past may be changing now or may change in the future.

From a purely scientific standpoint, in some embodiments the best way to determine the causal effects of operational component choices would be to execute a randomized controlled experiment (analogous to a clinical drug trial). For example, a retailer could randomly assign some stores to sometimes have a product located at different candidate in-store locations and observe the impact of those in-store location manipulations on actual business performance. Likewise, the retailer could randomly assign stores to carry or not carry a product and measure the causal impact of having versus not having a product available for purchase. Executing such experiments, however, would be resource-intensive and operationally disruptive. Furthermore, even if they were executed and optimal policies were validly determined at time T1 for all stores, it would be impossible to know if those policies are still optimal after time T2 (where T2>T1), given the dynamic nature of retail in which business conditions, market conditions, and customer behavior are constantly changing.

Traditionally, the goal of determining the business value of offering each stock keeping unit (SKU) would tend to be dealt with independently via standard methods (e.g., statistical modeling, data analysis, data mining, business intelligence, and the like). As used herein, a SKU may refer to a number or other identifier used to track inventory and differentiate items/products, such that multiple instances of the same exact type of item/product would have the same SKU, whereas items/products having a different price, manufacture, make, model, color, style, type, size and/or the like would have a different SKU. For example, analysts would examine the sales rates, profit margins, and the like, of each of the SKUs, including possibly customer choice modeling, and create statistical/mathematical models that would then be used to generate predictions about the business impact of the SKUs being offered at different stores or at different locations in different stores. Then, they would prioritize the SKUs with the highest predicted business impact. In some embodiments, an optimal way to determine these answers (the values of offering different SKUs) would be to execute a randomized controlled experiment (analogous to a clinical drug trial). For example, the retailer could randomly assign some stores at certain times to offer different SKUs as part of their assortment in specific locations and observe the impact of those manipulations on actual business performance. However, executing such experiments would be resource intensive, and even if they were executed and optimal policies were validly determined at time T for all stores, it would be impossible to know if those policies are still optimal after time T given the dynamic nature of retail in which business conditions, market conditions, and customer behaviors are constantly changing.

Instead of using either of these approaches (modeling observational data or executing experiments to drive later policy decisions), the operational components may be integrated into store operations to effectively execute one continuous adaptive clinical trial. This integrated operational process may determine the answers to optimality (increasing causal knowledge) while also applying those answers to improve business results through probabilistic execution. Furthermore, because the process is running continuously, it can dynamically adapt to changing business conditions, market conditions, and customer behaviors.

While it might seem that the integration of some embodiments would greatly increase the complexity of retail operations, the opposite is true because embodiments are designed to integrate in the spaces where existing retail operations already operate with uncertainty. For example, when a new product becomes available, various decisions should be made: Which stores should offer the new product? How much of the product should be offered at each store? Within each store, where should the new product be placed within each candidate planogram? What existing product(s) should be removed to make space for the new product? Analysts and decision-makers make their best judgments amid uncertainty. Moreover, the process of decision-making in the face of uncertainty over time may naturally lead to a diverging number of unique assortments. Instead, integrated into these uncertainty spaces, embodiments provide direction to employees as to what to do in practical terms while behind the scenes continuously providing the benefits of an adaptive clinical trial.

There are numerous potential benefits to the embodiments describe herein in comparison to traditional approaches. First, the adaptive experimentation is naturally externally valid because it is happening directly in the real world. Thus, there is no need to transfer experimental outcomes from a separate environment into the real world. Second, in contrast to establishing static policies via experimentation, a continuous, integrated, adaptive clinical trial type approach can create causal knowledge and/or causal knowledge-based operating policies that are automatically adjusted to changes in the real world as they happen. Third, the generation of causational data can be dynamically adjusted from retail operations within the bounds of uncertainty by balancing knowledge acquisition (such as observing causal relationships) with knowledge application (such as generating actionable direction from the causational data).

Instead of dealing with multiple operational components independently, the interrelationships may be managed between different retail goals. This may be accomplished, by way of non-limiting example, by allocating decisions as a queue optimization problem to balance the costs and benefits of decision making in uncertainty spaces. This overall queue optimization approach may provide an objective feedback loop to understand and apply causal knowledge about queuing decisions and constantly update the queue to maximally impact business results.

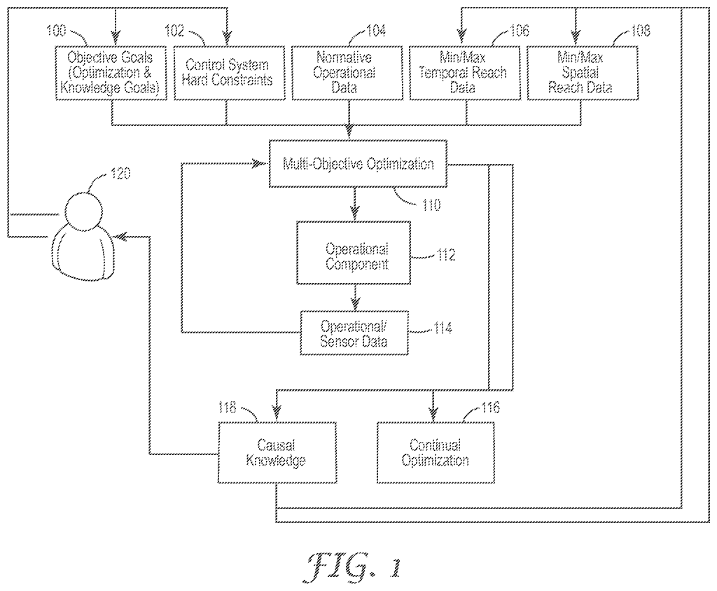

Referring now to FIG. 1, a diagram for controlled experimentation and modeling of operational resources is schematically depicted. At block 100, objective goals such as optimization goals and/or knowledge goals may be utilized as multi-objective optimization input. Objective goals may be utilized for optimization to scientifically address whether and how to prioritize the allocation of limited operational resources across various operational components. Optimization goals may be utilized to define which business outcomes should be maximized and/or minimized. By way of non-limiting examples, business outcomes can be measured using various figures-of-merit such as: currency sales per day per store, unit sales per day per store, gross profit per day per store, etc. In other non-limiting example, an objective goal may be to maximize the business impact of offering versus not offering a SKU in a store, such that any change in mix and/or quantities of the SKUs in a store would result in a reduced business outcome.

For out-of-stocks, an objective goal may be to maximize the business impact of fixing out-of-stock while minimizing the employee time and/or other resources allocated to fixing those out-of-stock conditions. The benefit of minimizing this component of employee time in this embodiment is that the employee is available for other important store services like helping customers. For assortment optimization, an objective goal may be to generate optimal assortment on a per-store basis, such that the mix of SKUs available at a given store maximizes sales and profitability, while also minimizing the number of customers that leave a store without purchasing a given category of SKUs in which they would have made a purchase had a specific SKU been available. This objective goal, however, need not be defined in terms of a SKU category goal, as one could use all SKUs in the aggregate, by way of non-limiting example. Yet for customer experience purposes, and satisfying long term loyalty to the retailer, operating at a SKU category level is rational. For in-store product location, an objective goal may be to maximize the business impact of having versus not having a SKU available at a given category of locations within a store, such that given the store level assortment of the SKUs, any change in location of the SKUs in a store category would result in smaller sales/profitability.

For planogram optimization, an objective goal may be to optimize the configuration of the SKUs within a planogram, such that any change in the location of the SKUs would decrease the POS/business results and/or increase the number of consumers who leave the store without purchasing an item from the SKU category. For customer substitution behaviors, an objective goal may be to maximize knowledge of which SKUs consumers will or tend to substitute for other SKUs in the event a given SKU is unavailable, and to capture this in terms confidence intervals for a pairwise matrix of SKUs or in terms of SKU attributes, by way of non-limiting example. For multi-item purchase patterns, an objective goal may be to maximize knowledge of which SKUs customers will and will not purchase together and how those patterns relate to out-of-stock situations. By way of non-limiting example, if SKU X is out-of-stock, customers will not buy SKU Y that is in-stock because they always buy X and Y together. Knowledge goals, by way of non-limiting examples, may include optimally balancing knowledge acquisition/generation with knowledge application (i.e., explore versus exploit), increasing causal knowledge (customer substitution behaviors, queuing decisions), existing knowledge (product location, customer purchase patterns), and the like. For example, as knowledge is gained and knowledge goals are met, the system may start to exploit that knowledge and customize treatments to different situations to increase business value and impact.

Turning to block 102, control system constraints, such as control system hard constraints and/or soft constraints, may be utilized as multi-objective optimization input. Constraints may be used to describe parameters for control signal assignments/activities that are allowed or disallowed. Constraints may also describe the bounds of uncertainty in current operational processes. Constraints may be known and clearly defined before starting adaptive experimentation, or they may be discovered later. More specifically, in some embodiments soft constraints may be “best practices” or other optional/semi-optional restrictions that may be ignored if needed by other conditions. By way of non-limiting example, a soft constraint may involve whether it is impossible to have both SW and GW at the checkout, versus it just merely being an option that has never been tried before. By contrast, in some embodiments hard constraints may not be ignored and must always be followed, which can create irreconcilable conflicts if hard constraints are overused or misapplied.

As discussed herein, retailers may have long-established practices and procedures for determining product assortments, but many of these decisions are made amid uncertainty. Identifying this uncertainty in embodiments may be crucial as this is where the optimization opportunity lies. Subject matter experts may or may not be aware of this uncertainty. It is important in some embodiments to identify the hard constraints that the system cannot violate (e.g., SKU A must be offered in all stores). However, it may also be important at the same time not to over-constrain the system by carefully differentiating true hard constraints from normative “best practices”. For example, can SKU A not be included in the assortment in rare cases? Once identified, constraints may be managed in two primary ways. First, subject matter experts as human operators may entirely manage the identification and honoring of constraints outside of the system. This may be accomplished by subject matter experts carefully specifying the independent variables in ways that honor the required/hard constraints. In some embodiments, the operational components do not have to know explicitly about the constraints. Second, constraints may be codified into the system such that it can enforce those rules automatically, without human operators managing the honoring of constraints.

In an example for out-of-stocks, a constraint may define how and/or when fixing such out-of-stock happens (for example, always fixing out-of-stock instances for certain SKUs or only fixing out-of-stock instances for which the estimated total business cost of an SKU being out-of-stock for a contiguous time period exceeds a specific threshold value), as well as constraints with regard to resources and/or employee time (for example, employees cannot be interrupted when helping a customer). In an example for assortment optimization, a constraint may define limitations on the mix of SKUs available on a per-store basis (for example, certain SKUs must always be included in the assortment or excluded from the assortment). In an example for in-store product location, a constraint may define limitations on where a SKU can be located within each store (for instance, in a physical store, certain SKUs can only be sold in an aisle or endcap, but not in a checkout line). In an example for planogram optimization, a constraint may define limitations as to how SKUs are arranged overall (for example, item X must be on the top shelf) or relative to one another (for example, item X must not be next to item Y). In an example for customer substitution behaviors, constraints may include knowledge about SKUs commonly purchased together gained from other components (which could limit the potential to estimate substitution between such SKUs), which means that these are not direct constraints but rather are observationally derived constraints. In an example for multi-item purchase patterns, a constraint upon a multi-item purchase pattern itself may include a lack of specific products in specific stores that prevent purchase patterns from being estimated.

Turning to block 104, normative operational data in embodiments may capture the standard/best practices that currently exist in retail operations and are believed to best achieve the optimization goals and may be utilized as multi-objective optimization input. Normative operational data may be data that captures the standard or best practices as they exist at any given time in the operations being modeled and are believed to best achieve the results and/or optimization goals sought. These normative practices may serve as the starting point for system execution such that implementation of embodiments can be made to change existing operations gradually, such that drastic change is not needed. In embodiments, normative operational data examples may include daily or transaction-level sales and inventory data or derivatives thereof for all processes.

An example for addressing out-of-stock instances may utilize the existing rules and behaviors for managing out-of-stock situations (for instance, reorder points, employee time prioritization, out-of-stock detection and fixing procedures, and the like). An example for assortment optimization may utilize the standard mix of SKUs included in assortments at different stores (or points of sale, whether they be brick-and-mortar or online retailers) depending on the best practices and store and item characteristics (for instance, SKUs that are frequently versus rarely included in an assortment). An example for in-store product location may utilize the existing knowledge and best practices in an industry or store type (or points of sale, whether they be brick-and-mortar or online retailers) for locating a SKU within a store. An example for planogram optimization may utilize the existing knowledge and best practices regarding the organization and arrangement of SKUs at a given SKU location within a store. By contrast, customer substitution behaviors would not generally rely on such data. In another example, however, multi-item purchase pattern behavior may utilize data captured from basket purchases (e.g., looking at real data of SKUs purchased together) to use existing knowledge of the frequency, probability, and/or other information regarding the purchase of multiple SKUs together.

Turning to block 106, temporal reach data may be utilized as multi-objective optimization input. Minimum and maximum temporal reach may bound and subsequently account for (e.g., optimize for) temporal carryover effects. Temporal reach may also be the subject of experimentation, in which by way of non-limiting example, the minimum and maximum temporal reach are varied stochastically in order to experimentally determine target values for temporal reach with respect to any given independent variable. Temporal carryover may happen when the effects of actions taken in a given time period “bleed over” into or have a causal effect upon actions in a subsequent time period. For example, a customer may respond to a changing condition (e.g., a change in a SKUs out-of-stock status) over the course of multiple visits to a store, such that the effects may not be immediate. In this non-limiting example, a customer may substitute a purchase of item 2 for item 1, but only after they have experienced multiple out-of-stock instances of item 1, such as after having returned to a store multiple times to find item 1 out-of-stock. Some embodiments may account for temporal reach by measuring how long in time an effect will be measurable, and in some embodiments, this may be done in terms of the effect on retail operations under consideration. As further discussed herein with respect to the assortment operational component, min/max temporal reach may represent the estimated minimum and/or maximum amount of time that customers will react to product assortment changes because min/max temporal reach may be used to bound and subsequently optimize temporal carryover effects. More specifically, temporal carryover may happen in this embodiment when the business impacts of actions taken in a time epoch bleed over into subsequent time epochs.

Temporal reach effect on retail operation examples may include in the context of the out-of-stocks, using temporal reach minimum and maximum values to represent the amount of time that a customer will react to an out-of-stock situation (e.g., a SKU being unavailable for purchase). This may generate data indicating the temporal reach during which time fixing an out-of-stock condition will have an effect on a retail operation under consideration. In another example, assortment optimization may use temporal reach to represent the amount of time that a customer will react to a change in the assortment available for purchase (e.g., a SKU being added to or removed from an assortment in a given store or point of sale). This may generate data indicating the temporal reach during which time an assortment change will have an effect on a retail operation under consideration. In another example, in-store product location may use temporal reach to represent the amount of time that a customer will react to a change in a product location in a given store (e.g., a SKU being available for purchase at a particular location within a store). This may generate data indicating the temporal reach during which time moving a SKU to a different location in the store will have an effect on a retail operation under consideration. In another example, planogram optimization may use temporal reach to represent the amount of time that a customer will react to a change in the planogram of SKUs available for purchase (e.g., rearranging SKUs on a shelf or in a given space, whether a physical space or on a web page or other arrangement of SKUs). This may generate data indicating the temporal reach during which time changes in a planogram will have an effect on a retail operation under consideration. In another example, customer substitution behaviors may use temporal reach to represent the amount of time that customer substitution probabilities and/or estimated multi-item purchase pattern behaviors are accurate representations of true customer behaviors. In another example, multi-item purchase pattern behaviors may use temporal reach to represent the estimated minimum and/or maximum amount(s) of time that estimated purchase pattern probabilities are accurate representations of true customer purchase patterns across multiple SKUs. In addition, for both customer substitution probabilities and multi-item purchase patterns the temporal reach may represent the amount of time needed to estimate new behaviors after a treatment has been applied.

Turning to block 108, spatial reach data may be utilized as multi-objective optimization input. Minimum and/or maximum spatial reach may be utilized to bind and subsequently account for (e.g., optimize for) spatial carryover effects. Spatial reach may also be the subject of experimentation, wherein, for instance, the minimum and maximum spatial reach are varied stochastically in order to experimentally determine target values for spatial reach with respect to any given independent variable. Spatial carryover happens when the effects of actions taken in one spatial region may spill over into adjacent spatial regions (e.g., physical spatial regions, or within a web page of an online retailer, or as between a succession of web pages viewed sequentially). Furthermore, in considering spatial reach in a physical point of sale setting, spatial reach may be affected by customers visiting multiple nearby stores, not only the spatial reach within a given store. In some embodiments, stores need not be of the same chain, retailer, company, and the like. Min/max spatial reach in the context of the assortment operational component may represent the extent (if any) to which changes in product assortment at one store may impact or spillover into optimization goals measured at other stores or at the same store for other product categories. This is because min/max spatial reach may be used to bound and subsequently optimize spatial spillover effects. Spatial spillover may happen when the business impacts of actions taken in one spatial region bleed over into adjacent spatial regions.

Spatial reach may be accounted for by estimating how far into space effects will be measurable in terms of the retail operations under consideration. The effect of spatial reach upon retail operation may include, for example, using spatial reach values to represent the extent to which out-of-stock actions at one store or at one location within a store. This may affect or spill over into retail operations under consideration in other stores or other locations within the same store.

In another example, assortment optimization may use spatial reach to represent the extent to which assortment actions at one store or at one location within a store. This may affect or spill over into retail operations under consideration in other stores or other locations within the same store. In another example, in-store product location may use spatial reach to represent the extent of changes in the location of an item. This may affect or spill over into retail operations under consideration with regard to a second item location in other stores or other locations within the same store.

In another example, planogram optimization may use spatial reach to represent the extent to which changes in a planogram may affect or spill over into retail operations under consideration with regard to either a second unchanged portion of the same planogram or with regard to other item locations in other stores or other locations within the same store. In this embodiment, neither customer substitution behaviors nor multi-item purchase pattern behaviors are particularly relevant.

Turning to multi-objective optimization at block 110, by way of non-limiting examples, the objective goals, constraints, normative operational data, temporal reach data, and/or spatial reach data may be utilized as inputs. An aspect of some embodiments is that resource optimization may be happening at an individual operational component level. That is, multi-objective optimization could operate on any one goal independently. For example, multi-objective optimization could address assortment optimization only, or product location optimization only. However, an important feature of some embodiments is the technological improvement of using multi-objective optimization to simultaneously optimize all the operational components and their interactions.

Specifically, it is a technical improvement to execute this coordination in some embodiments because if each operational component were merely optimized independently, they would inevitably conflict with each other. The independent knowledge generation objectives and optimization goals would collide, and optimization goals from different operational components would conflict. For example, the assortment optimization operational component might specify certain stores to have and certain other stores to not have a given SKU in their assortment at a given time. At the same time, the product location optimization operational component might specify that certain stores should have the same SKU at an endcap and other stores should only have it only in an aisle, while still other stores should have it at both locations. However, if any of the product location stores are the same stores that assortment optimization specifies not to have the SKU at all, then there would be a conflict. Another example is the inherent conflict between customer substitution estimation and fixing of out-of-stock instances. If no out-of-stock instances are fixed, then more accurate customer substitution probabilities could be estimated and retail employees could spend more time interacting with customers, but business performance could decline because fewer products are available for purchase.

This problem may be resolved in some embodiments by experimenting upon and optimizing the sequence in which different retail components are executed/queued, while also ensuring that subsequent operational components adhere to limitations imposed by a previously-executed operational component. For example, if the product location operational component executes first, it will de facto identify a set of stores that must have the SKU in question. When the assortment optimization operational component executes, in some embodiments it will not be allowed to assign any of the product location stores to not have the given SKU. Conversely, if the assortment optimization operational component executes first, it may assign in some embodiments certain stores not to have the SKU. Then, when the product location operational component executes, it cannot assign specific product locations to stores that do not already have the SKU. Thus, an important technological improvement provided by embodiments herein is the ability to experimentally and adaptively find the optimal queuing prioritization for the different actions that arise due to individual retail components.

Some embodiments herein may utilize an integrated, continuous, adaptive clinical trial via a suitable multi-objective optimization approach, such as, by way of non-limiting examples, reinforcement learning, multivariate optimization possibly including non-commuting variables like Grassman variables, a deep causal learning platform, Markov chains, or any other suitable approach as would be known to one of ordinary skill in the art. Additional approaches may include multi-armed bandit (i.e., based upon choice properties only partially known at the outset and learned with the passage of time/choices, choosing between competing choices, such as explore vs exploit, to maximize gain using finite resources), standard adaptive clinical trial logic (i.e., double-blind randomization), and the like. Moreover, using an integrated, continuous, adaptive clinical trial, the control signals may be prescribed (e.g., replenish a specific SKU at a specific location within a specific store) within and across retail store locations, and there are several computational/algorithmic systems that could be used to execute such components (e.g., deep reinforcement learning, multi-arm bandits, standard adaptive clinical trial logic).

In one embodiment, multi-objective optimization may be used to implement queue optimization, as discussed further herein. Queue optimization may be utilized to operate in spaces where action already needs to be taken and there is uncertainty as to what the best action is. Instead of simply taking what seems like the best course, the opportunity may be taken to experiment, which may inherently result in experimenting in the search space areas where there is ambiguity and, importantly, avoids experimentation in areas that do not require it. By way of non-limiting example, audit and inventory correction queues may be prioritized based upon multi-item purchase patterns of customers, as further described herein. By identifying SKUs that are frequently purchased together, retailers may prioritize the queues of both SKUs to continue servicing the customer. Conversely, deprioritizing independently-purchased SKUs impacts only those particular SKUs, not the sales of other SKUs in the store, in some embodiments.

In some embodiments, reinforcement learning may be utilized for reward maximization in a situation/scenario based upon available/possible actions/inputs, with the aim being to discern a best behavior/sequence/path for a particular situation/scenario. Put another way, reinforcement learning is directed towards sequential decision making. Thus, labels may be given to sequences of dependent decisions (i.e., a current output depends on the current input, so that the next input depends on the current output), with non-commuting variables like Grassman variables used to distinguish sequences where the same set of dependent decisions are made but in different orders. For example, given an initial state (input, such as replenishing a specific SKU at a specific location within a specific store) and all possible outcomes/solutions (output, such as an effect on sales of the item at the specific store) for a situation, a potential reward amount can be incremented/decremented along with the way. To train a model, when it returns an output based upon the current input, each can be labeled as a reward or decrement. Solutions may be ranked and the optimal solution may be based upon summation of all possible outputs within each behavior/sequence/path.

Regarding embodiments utilizing multivariate optimization, multiple variables may be utilized such that each serves as a decision variable within an optimization problem in which a function's output is maximized/minimized based upon inputs from an allowed set of inputs. While a univariate optimization approach may be utilized where there are no constraints (see constraints discussed herein, such as not selling GW next to SW), multivariate optimization may be subject to equality constraint(s) (i.e., mathematical expressions that represent the same mathematical object or quantities that represent the same value, such as the equal sign notation) and/or inequality constraint(s) (i.e., non-equal comparison among mathematical expressions or numbers, with exemplary representative notations including less than, greater than, less than or equal-to, greater than or equal-to, and the like).

Regarding embodiments utilizing deep causal learning, returning to the non-limiting GW/SW example, deep causal learning may be used to prescribe control signals (e.g., replenish a specific SKU at a specific location within a specific store) within and across retail store locations. Deep causal learning has been described elsewhere, including in WO2020/190326, WO2020/190324, WO2020/190325, and WO2020/190328. Regarding embodiments utilizing Markov chains, stochastic models (typically a mathematical object having a family of random variables) may be utilized to illustrate a series of potential moves/outcomes where the associated probability of each move/outcome is solely determined by the current move/outcome and not the previous move(s)/outcome(s) in the sequence. In some embodiments, continuous-time Markov chains may be utilized in the context of random processes whose values may be changed at any time.

Turning to block 112, each operational component may treat their optimization task as one among many retail operational components and to treat their interrelationships as a queue optimization problem and experiment, whereby algorithmic modules (such as the operational components described herein) may direct adaptive randomized controlled trials on the allocation of operational resources within and across the operational components. These adaptive randomized controlled trials may explore and/or exploit the causal structure of the problem-spaces of each individual component and their interrelationships and thereby improve outcomes within the operational components and rationalize and improve the allocation of resources within and across the operational components described herein.

The operational components described herein may, in some embodiments, rationally optimize available and unavailable SKUs as a function of confounding variables, both measurable and unmeasurable, within stores in the context of multiple retail operations, to manage the priorities and rationalize the relationships optimizing the singular goal. By using randomly controlled experiments, the entire process may become recursive, constantly improving, and knowledge-generating while still improving business results. In this embodiment, the retailer may retain the ability to learn the absolute value of offering a product at a store due to continuously following the same patterns. Thus, by naturally integrating the resolution of each question, the retailer may simultaneously discover, learn, and make a difference to their business. As further described herein, retail operations in the form of operational components that pertain to out-of-stocks, assortment, in-store product location, planogram, customer substitution, and multi-item purchase patterns.

As discussed further herein with respect to the out-of-stock operational component, when the term out-of-stock is used herein, it may have a more nuanced meaning in some embodiments than may be generally understood and may mean that an item is not available for purchase. For this reason, it may also be referred to herein as product unavailability. In this case, it might be that the item is not on the shelf at a retailer, or it may be that it is mis-shelved and not findable by a customer wishing to make a purchase. An item may be out-of-stock and thus unavailable, even if an inventory management system indicates that an item is in fact in-stock. Such a situation may be referred to as “phantom inventory”.

As discussed further herein with the respect to the assortment operational component, when the term assortment is used herein, it may pertain to the mix of SKUs available in a given store (which may be brick and mortar, online, or any other product offering suite). When adjusting assortment, business goals may include by way of non-limiting examples the increasing of overall sales, increasing total profitability of sales, reducing the number of different SKUs offered in order to reduce supply chain costs, minimizing the number of customers that leave a store without making a purchase in a given category of SKUs (where they would have made one had a specific SKU been available). Such goals may be complimentary, such that similar actions of adjusting assortment may lead to positive results in one or more of these goals. It may also be, however, that adjustments that improve one goal cause are detrimental to another goal, and values must be weighed and adjusted in arriving upon a course of action.

As discussed further herein with respect to the in-store product location operational component, when the term in-store product location is used herein, it may encompass the physical location within a brick-and-mortar store (e.g., in an aisle, in an end-cap, at check-out, and where, within the store, any or all of these is located). Alternatively, it may mean how, where, and in what context an SKU is presented by an online retailer (e.g., highlighted at a home page, in a “recommended” list, in a side-bar, in a list of “customers also bought”, and the like). In this regard, some embodiments allow for determining the business impact of having versus not having a particular SKU available at a given category of locations in a store, such that given the store level assortment of the SKUs, any change in location of the SKU in the store would result in a change in a business result (a change in overall sales, profitability, time spent in-store, customer experience, and the like).

As discussed further herein with respect to the planogram operational component, when the term planogram is used herein, it may refer to the physical arrangement of SKUs at a given location within a store. It may be that a planogram is determined at a store level, at the level of a section or some subset of a store, or at the level of an aisle or even a portion of an aisle. In some instances, planogram may refer to the physical arrangement of related SKUs or even SKUs of the same type. By way of non-limiting example, a planogram for a home improvement store may refer to the arrangements of all SKUs relating to painting, including not only paint options, but also brushes, pans, rollers, masking tapes, drop cloths, ladders, lighting, protective eye-wear, sprayers, primers, and other SKUs associated with painting. The planogram would also include the relative location in an aisle and the shelf/vertical position of each SKU. Some embodiments may allow one to determine how configurations of SKUs within a planogram affect the sales or other business results (such as, for instance, profitability or the number of customers who leave the store without purchasing from a given category of SKUs).

As discussed further herein with respect to the customer substitution operational component, when the term customer substitution is used herein, it may refer to those SKUs that customers may substitute for other SKUs if a given SKU is unavailable. Some embodiments may utilize confidence intervals for a pairwise matrix of SKUs or even a pairwise matrix of SKU attributes (e.g., price or usage application and the like), to the extent that such attributes are knowable, generalizable, and traceable.

As discussed further herein with respect to the multi-item purchase pattern operational component, when the term multi-item purchase pattern is used herein, it may refer to those SKUs that a customer tends to purchase or not to purchase together. Some embodiments may allow one to find causal relationships between how multi-item purchase patterns may relate to item availability (e.g., if item X is unavailable for purchase, customers will tend to not purchase item Y that is in-stock because SKUs X and Y tend to be purchased together).

Turning to block 114, operational/sensor data may be derived to measure various outputs (point of sale, inventory, product location, and the like) from having one or more operational components integrated into retail operations (e.g., store operations) to effectively execute as one continuous adaptive clinical trial. When integrated with operational components, some embodiments described herein allow for the creation of causational data sets while at the same time applying the learnings from those causational data sets to improve retail operations. Furthermore, when some embodiments described herein are running continuously, in some embodiments they may adapt to observed changing business conditions, market conditions, and/or customer behaviors. This allows not only the creation of predictive models (as is the traditional approach), but also the real-time improvement of causational data sets so that speculative predictive models become, in many cases, obsolete.

Turning to block 116, continual optimization may be derived from data received from multi-objective optimization. Instead of using only the observational experiment approach (modeling observational data) or only the active experimentation approach (to drive later policy decisions), one or more embodiments are integrated into store operations to effectively execute one continuous adaptive clinical trial where each round of trials is informed by recently collected data from observational experiments. This integrated operational process may be used to determine the answers of optimality (i.e., increasing causal knowledge) while also applying those answers to improve business results through probabilistic execution. Furthermore, because embodiments may be running continuously, they can dynamically adapt to changing business conditions, market conditions, and customer behaviors. Thus, embodiments may integrate experimentation into normal operations, such that knowledge is continuously gained and refined. Because experimentation becomes part of normal operations in such embodiments, the burdens of centralized control and costs are significantly reduced. Finally, the experimentation naturally operates in the context of existing best practices while adapting to changes in the real world.

Turning to block 118, causal knowledge of the effects of changes within the various operational components on business performance may be obtained as data received from multi-objective optimization. An optimal way to determine values of the various operational components discussed herein may be to run randomized controlled trials to acquire this causal knowledge. While some retailers may execute simple experiments, these are not conducted in a randomized or scalable fashion. Existing experimentation approaches are typically separated into an experimentation phase, where knowledge is gained, and an implementation phase where acquired knowledge is applied. There are several key drawbacks with this approach. First, to maximize knowledge gain, the experimentation phase may require significant deviation from best practices and/or increased costs. Second, once the implementation phase begins, experimentation stops, and no additional knowledge is gained. Third, experiments may often be executed at too small of a scale, or if executed at a sufficiently large scale, may require substantial centralized control and significant cost.

Some embodiments are designed to integrate into the spaces where existing retail operations already operate with uncertainty. By way of non-limiting example, out-of-stock instances happen regularly and cannot all be fixed, which leaves retail employees to make judgment calls about what course of action to take amid uncertainty of causal outcomes. Instead, when some embodiments are deployed with regard to such decisions, causational data is generated and employees can determine what actions to take, in practical terms. Furthermore, once such actions are taken, some embodiments continue to observe and improve the causational data sets, thus determining changes in causational relationships in near real-time.

In one non-limiting example to develop causal knowledge, given that out-of-stock situations arise naturally in retail environments (such as when a product becomes unavailable for purchase), experience, especially with regard to brick and mortar retail facilities, is that the cost of fixing all of them may be operationally too high compared to the value realized by actually doing so. Rather than fix them according to standard practice and procedures, some embodiments may use the opportunity of an item being unavailable for purchase to experiment on the operational value of fixing or not fixing a given out-of-stock condition. Some embodiments may vary the control signal of such conditions (i.e., fix or not fix the out-of-stock) across stores and within a store at different times, in order to estimate the confidence interval with which knowledge is generated regarding the value of fixing or not fixing the out-of-stock condition. Some embodiments may explore and exploit accordingly to develop causal knowledge regarding the value of fixing or not fixing an out-of-stock condition. The information gained in this process can provide data regarding customer substitution behaviors, multi-item purchase patterns, and the business value of offering each item at any specific store. Causal knowledge may provide output to update the temporal reach data and/or spatial reach data.

A human-in-the-loop 120 may receive causal knowledge data and update the objective goals and/or the constraints. A human-in-the-loop may in turn determine what data is provided to update the objective, which may involve a standard randomized controlled experiment where one or more humans in the loop participate in the form of a standard randomized controlled experiment. This may be analogous to a standard clinical drug trial (where the patients are analogous to stores and the drugs are analogous to assortment conditions). Note that in this non-limiting example, there are three executional methods of implementing the experiments for this feedback loop, with humans in the loop being one. A second type relies on fixing out-of-stocks as the opportunity to manipulate the independent variable(s) as described with respect to the assortment operational component herein. A third type is part of an adaptive clinical trial as described herein. By way of non-limiting example, hypotheses can be refined and prioritized based on, by way of non-limiting example, subject matter expert knowledge and judgment utilized in hypothesis refinement methods may have a human-in-the-loop 120.

As a further non-limiting example discussed later herein, hypothesis refinement methods may or may not utilize human-in-the-loop 120. The definition of independent variables can lead to a large search space for experimentation that may be prohibitive for full exploration in some embodiments. In this case, hypotheses can be refined and prioritized based on, by way of non-limiting examples: (i) subject matter expert knowledge and judgment, (ii) descriptive data analysis, (iii) known customer substitution behaviors to drive richer customer substitution behavior knowledge, and/or (iv) known multi-item purchase pattern behaviors to drive richer multi-item purchase pattern behavior knowledge.

Utilizing a non-limiting example of this experimentation, in the context of out-of-stock optimization, given that out-of-stocks happen, it is not possible to fix them all. Rather than simply fixing them based on standard practices, the opportunity may be used to experiment on the value of fixing or not fixing a given out-of-stock condition. Based on multi-objective optimization, control signals (e.g., fix or do-not-fix and the like) may be varied across stores or even within stores at different times to estimate confidence intervals on the value of fixing or not fixing an out-of-stock situation. Explore and exploit may accordingly be utilized based on the confidence intervals. As discussed further herein, these control signals may provide input to customer substitution behaviors and multi-item purchase patterns.

Continuing with this non-limiting example in the context of assortment optimization, when out-of-stock conditions happen, it may be an opportunity to experiment on assortment, such as where a SKU is completely out-of-stock in the store. Instead of fixing the out-of-stock, sometimes it may be recommended to leave the out-of-stock as-is while fixing the same out-of-stock situation in at least one other store (or at the same store at a different time). In this way, confidence intervals on the value of including or excluding the SKU in the assortment can be estimated. Explore and exploit accordingly may be utilized based on the confidence intervals. In addition, assortment experimentation can be executed directly/proactively, rather than always waiting for out-of-stock conditions, if the opportunity-cost makes it worthwhile.

Regarding in-store product location optimization continuing with this non-limiting example, out-of-stock conditions may happen only at some location(s) for a product that is offered at multiple locations within a store. This may be an opportunity to experiment by choosing to fix or not fix the out-of-stock condition(s) at those location(s). Fixing may involve replenishing from overhead or backroom stock, or it may simply involve moving SKUs from one location to another so that no location is out-of-stock. Based on multi-objective optimization, treatment (fix or do-not-fix) for out-of-stock condition(s) may be varied at specific locations across stores or even within stores at different times to estimate confidence intervals on the value of having a SKU at a given location. Explore and exploit may accordingly be based upon the confidence intervals. Product location optimization may also be executed directly/proactively rather than always waiting for out-of-stock conditions if the opportunity-cost makes it worthwhile.

Regarding planogram optimization continuing in this example, out-of-stock conditions may happen within a planogram of a given store location. This may again be an opportunity to experiment by choosing to fix or not fix the out-of-stock condition(s) within the planogram. In similar multi-objective optimization fashion, by fixing or not fixing at different stores or within stores at different times, one can estimate confidence intervals for the value of having versus not having the SKU at given position of the planogram. The position of a given SKU (e.g., top shelf vs. bottom shelf) within the planogram can be varied across stores, and in this way, the value of different positions can be measured and estimated via confidence intervals. Explore and exploit may be utilized based on the confidence intervals, and planogram optimization can additionally be executed directly/proactively rather than always waiting for out-of-stock conditions if the opportunity-cost makes it worthwhile.

Regarding customer substitution behaviors continuing in this example, the various out-of-stock conditions may be used to compute uncertainty on customer substitution behavior both naturally/organically but also to intentionally fix (or not fix) out-of-stock situations in ways that better inform customer substitution behaviors. Regarding multi-item purchase patterns continuing in this example, various out-of-stock conditions may be used not only to compute confidence intervals on multi-item purchase patterns both naturally/organically, but also to intentionally fix or not fix out-of-stock situations in ways that better inform multi-item purchase patterns.

In embodiments, there are some critical technological benefits to this overall approach for controlled experimentation and modeling of operational resources (e.g., integrating this approach into every day operating conditions amid uncertainty) in comparison to previously-described approaches. First, the adaptive experimentation is naturally externally valid because it is happening directly in the real world, such that there is no need to transfer experimental outcomes from a separate environment into the real world. Second, in contrast to establishing static policies via experimentation, a continuous, integrated, adaptive clinical trial can automatically adjust to changes in the real world as they happen. Third, embodiments herein dynamically optimize the business within the bounds of uncertainly by optimally balancing knowledge acquisition with knowledge application leading to even more optimal decisions in the future.

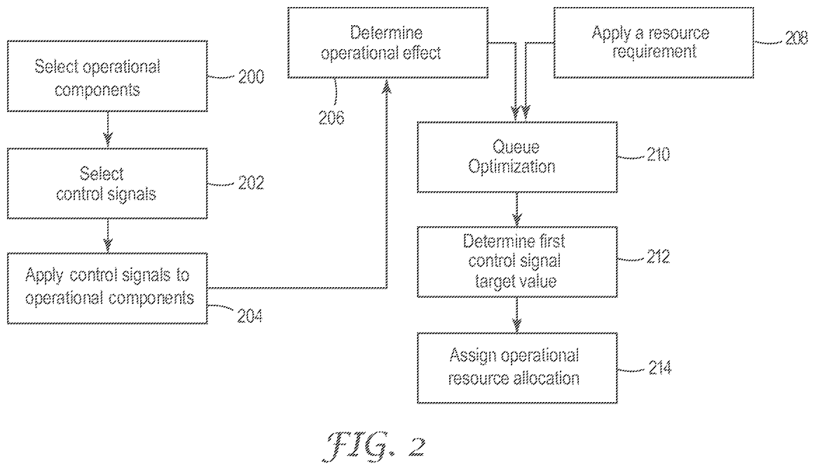

Referring now to FIG. 2, a flow diagram depicts applying control signals to operational components to determine operational resource allocation according to embodiments herein. At block 200, a plurality of operational components may be selected, to which operational resources may be allocated. The operational components may include out-of-stock (to which resources may be allocated to fix or not to fix the out-of-stock), assortment (to which resources may be allocated to change the assortment, for example either by replenishing a specific out-of-stock condition or by redesigning the assortment), in-store product location (to which resources may be allocated to change the in-store product location, for example either by replenishing a specific out-of-stock condition or by redesigning the in-store product location), planogram (to which resources may be allocated to change the planogram, for example, either by replenishing a specific out-of-stock condition or by redesigning the planogram), substitution (to which resources may be allocated in response to knowledge of which SKUs consumers will or tend to substitute for other SKUs in the event a given SKU is unavailable), and/or multi-item purchase patterns (to which resources may be allocated in response to knowledge of which SKUs customers will and will not purchase together and how those patterns relate to out-of-stock situations).

At block 202, a plurality of control signals may be selected for the plurality of selected operational components. Such control signals may indicate discrete values for the operational components, describing, for instance, any particular condition pertaining to out-of-stock, assortment, in-store product location, planogram, substation, and/or multi-item purchase patterns. The flow diagram may further comprise applying the control signals to the operational components at block 204 and determining the operational effect of the control signals at block 206. Here, by operational effect, it may mean any of a number of operational effects such as the effect on overall sales in a store, the effect on profit margins in a store, the effect on the inventory levels of a store, the effect on the ordering and replenishment activities of a store, and the like.

The present flow diagram may further comprise, in some embodiments, applying a resource requirement to some or all of the plurality of operational components at block 208. In one aspect, this may be considered to be the “cost” of taking or not taking action with regard to an operational component. For instance, a method that only determines the operational effects of out-of-stock conditions may find that an optimal or ideal solution would be to fix all out-of-stock conditions. Alternatively, a method may determine that customer substitution behaviors lead to the purchase of higher price or higher profit margin SKUs when certain other SKUs are out-of-stock, thus suggesting that while replacing some out-of-stock SKUs is desirable, replacing others may be less desirable, depending upon which operational effect(s) one is attempting to optimize. Such an analysis, however, may not take into account the costs in terms of resource requirements for fixing a given out-of-stock (such costs may take the form of, for instance, the cost of a retail employee's time, decreased time for customer-employee interactions, higher inventory demands to ensure replacement stock is on hand, and the like).

The present embodiment further may utilize queue optimization at block 210 by receiving as inputs both the determined operational effect from block 206 and the applied resource requirement from block 208. In some embodiments, queue optimization operates in spaces where action can be taken and there is uncertainty as to what the best action is. In some cases, retailers may already be planning and making assortment changes. Instead of simply taking what seems like the best course, the opportunity may be taken to instead experiment. In other cases, the integration of the assortment operational component with normal operations can enable more frequent, iterative execution of assortment changes to both measure and optimize business results. The product assortment changes may be executed across many stores at once to accumulate an adequate sample size to estimate effects. However, the changes executed may be small and iterative in nature (e.g., swapping a facing of SKU A for a facing of SKU B), and in this way, product assortments may change in a gradual, adaptive fashion. Over time, small assortment changes that create demonstrated business value across stores may be implemented broadly. However, many product assortment changes might become idiosyncratic to small groups of stores. In this way, queue optimization in the context of the assortment operational component may naturally explore the search space and settle on both global and local optimums.

The queue optimization may be utilized to determine a first control signal target value at block 212, based on the operational effect of each of the plurality of control signals on each of the plurality of operational components and the resource requirement for each of the plurality of control signals for each of the plurality of operational components. That is, at the level of any one operational component, resource optimization may occur wherein a first control signal target value is determined via queue optimization, based on the resource requirement for taking such underlying action as is represented by the control signal. In this way, for instance, some embodiments can consider each of a plurality of operational components (e.g., out-of-stock, assortment optimization, in-store product location, planogram, substation, multi-item purchase patterns) individually, generating data that would indicate the optimum actions taken toward a given desired business outcome (the operational effect of each of the plurality of control signals). Some embodiments may also, however, use queue optimization as between operational components to simultaneously optimize all operational components and their interactions, taking into account uniquely the resource requirement of each of the plurality of control signals for each of the plurality of operational components. In this way, queue optimization may be utilized to compare the benefits and costs of applying specific sets of control signals (e.g., fix or do not fix an out-of-stock instance on the basis of customer substitution and/or multi-item purchase patterns, change or do not change an assortment, planogram, or product location, and the like) across all aspects of operational components in order to determine the optimal set of control signals.

Finally, an operational resource allocation may be assigned at block 214 to each of the plurality of operational components, based on the first control signal target value. Thus, this multi-operational-component queue optimization may be coordinated because if each of the plurality of operational components were optimized independently, they may conflict with each other in certain considerations and situations. For example, if a first control signal target value for the assortment optimization operational component is determined, it might indicate that certain stores should have and certain other stores should not have a given item in their assortment at a given time. When the first control signal target value for the in-store product location is determined, however, it might indicate that certain stores should have the same item at an endcap and other stores should only have the item in an aisle, while yet other stores should have the item at both. If, however, any of the in-store product location stores are the same stores that the first control signal target value for assortment indicated should not carry the item at all, that may produce a conflict between the conditions recommended by each of these first control signal target values. When the term “optimized” is used herein, it is generally meant determining a first control signal target value which may be the most desired value even if it is not “optimized” across all independent variables and outcomes, as it may not be possible to so optimize any given control signal target value.

Some embodiments may resolve the apparent conflict described above by experimenting upon the sequence in which different operational components are executed and/or queued, while also ensuring that subsequent operational components adhere to the limitations imposed by a previously-generated first control signal target value. By way of non-limiting example, if the in-store product location determination of a first control signal target value is determined first, it will de facto identify a set of stores that must have an item in question in its stock. Accordingly, when the assortment determination of a first control signal target value is determined, it will not be allowed to assign a store to exclude such item from its assortment. Conversely, if the assortment determination of a first control signal target value is determined first, it may assign certain stores to not have a particular item in their assortment. When the in-store product location determination subsequently executes, it will not be allowed to assign a store to place an item in any of the in-store product locations if that store was determined by the assortment determination to exclude such item. The preceding example, pertaining to assortment and in-store product location, is but one example of an aspect of embodiments which have the ability to experimentally and adaptively determine a target queueing prioritization order for the different operational components.

As example of the overall process in this embodiment, Table 1 below depicts a variety of information for 20 stores. Each store has between 10 and 20 SKUs. All the SKUs have a primary product location in the same aisle and planogram. Some SKUs are not offered at all in certain stores. At certain stores, some SKUs are offered in the aisle and on an endcap.

TABLE 1

| Store | POG | A | B | C | D | E | F | G | H | I | J | K | L | M | N | O | P | Q | R | S | T |
|---|---|---|---|---|---|---|---|---|---|---|---|---|---|---|---|---|---|---|---|---|---|
| 01 | 1 | 15/1 | 10 | 16 | 0^{d} | 0 | 9 | 19/6 | 9 | 20 | 23 | 11 | 7/6 | 9 | 8 | 0 | 13 | 8 | 9 | 9 | 3 |
| 02 | 1 | 32/4 | 14 | 16 | 16 | 19 | 14 | 15/2 | 0 | 21 | 23 | 0 | 9/3 | 0 | 11 | 10 | 0 | 6 | 9 | 7 | 3 |
| 03 | 1 | 21/5 | 8 | 9 | 13 | 22 | 16 | 0/4 | 0 | 21 | 21 | 16 | 11/0 | 9 | 9 | 9 | 7 | 6 | 6 | 6 | 0 |
| 04 | 1 | 0/1 | 0 | 18 | 18 | 12 | 12 | 27/5 | 16 | 20 | 13 | 9 | 12/2 | 3 | 17 | 0 | 8 | 0 | 8 | 5 | 2 |
| 05 | 1 | 15/3 | 9 | 12 | 0 | 14 | 11 | 17/6 | 8 | 12 | 19 | 7 | 6/3 | 8 | 6 | 11 | 12 | 9 | 5 | 5 | 7 |
| 06 | 1 | 16/3 | 6 | 0 | 12 | 23 | 8 | 0/2 | 14 | 19 | 17 | 5 | 0/3 | 8 | 10 | 12 | 9 | 6 | 13 | 0 | 3 |
| 07 | 1 | 0/5 | 12 | 17 | 13 | 19 | 14 | 0/0 | 8 | 12 | 15 | 7 | 8/4 | 0 | 8 | 11 | 9 | 9 | 0 | 6 | 3 |
| 08 | 1 | 15/3 | 6 | 21 | 16 | 0 | 13 | 15/3 | 0 | 17 | 18 | 13 | 6/2 | 9 | 0 | 2 | 12 | 11 | 0 | 9 | 6 |
| 09 | 1 | 23/5 | 0 | 18 | 9 | 0 | 13 | 11/8 | 14 | 16 | 17 | 9 | 8/2 | 9 | 15 | 7 | 0 | 5 | 6 | 5 | 3 |
| 10 | 1 | 26/3 | 7 | 18 | 13 | 25 | 17 | 16/2 | 14 | 19 | 15 | 8 | 8/3 | 5 | 8 | 11 | 7 | 6 | 7 | 5 | 6 |
| 11 | 2 | 22/0 | 0 | 16 | 21 | 17 | 12 | 13/7 | 14 | 16 | 12 | 7 | 7/0 | 6 | 13 | 14 | 4 | | | | |
| 12 | 2 | 19/0 | 7 | 20 | 9 | 13 | 21 | 12/4 | 8 | 19 | 12 | 9 | 13/7 | 3 | 17 | 9 | 0 | | | | |
| 13 | 2 | 19/5 | 10 | 12 | 16 | 15 | 0 | 17/4 | 17 | 23 | 13 | 0 | 0/4 | 6 | 0 | 6 | 4 | | | | |
| 14 | 2 | 21/8 | 4 | 24 | 12 | 15 | 15 | 17/0 | 0 | 21 | 19 | 0 | 15/5 | 14 | 14 | 0 | 5 | | | | |
| 15 | 2 | 17/3 | 10 | 16 | 16 | 19 | 16 | 16/4 | 17 | 19 | 17 | 9 | 7/2 | 0 | 13 | 11 | 5 | | | | |
| 16 | 2 | 23/1 | 0 | 0 | 17 | 11 | 13 | 23/0 | 14 | 10 | 15 | 9 | 9/4 | 0 | 0 | 0 | 3 | | | | |
| 17 | 3 | 0/3 | 9 | 25 | 17 | 17 | 19 | 20/4 | 11 | 20 | 13 | | | | | | | | | | |
| 18 | 3 | 24/3 | 0 | 15 | 13 | 18 | 0 | 19/5 | 20 | 24 | 18 | | | | | | | | | | |
| 19 | 3 | 23/5 | 0 | 19 | 16 | 14 | 15 | 10/3 | 19 | 22 | 14 | | | | | | | | | | |
| 20 | 3 | 23/2 | 6 | 9 | 21 | 27 | 22 | 0/0 | 0 | 25 | 18 | | | | | | | | | | |

The lettered columns represent items (e.g., item A, item B, item C, etc.). The numbered rows represent stores (e.g., store 01, store 02, store 03, etc.). The numeric values indicate current inventory levels for an item at a given store. A single number represents the inventory level at the main aisle within the store. Multiple numbers in a cell represent inventory levels at multiple locations within a store, where the first number represents the main aisle and the second number represents an end-cap. In the POG (i.e., planogram) column, stores 01-10 use a first planogram, stores 11-16 use a second planogram, and stores 17-20 use a third planogram. Where an item is out-of-stock, it is indicated as such with a “0” or a “0” value for number of items. Specifically, a value of “0” indicates easy restocking (e.g., additional stock is available in-store and can be replenished from such stock), and a value of “0” means not easily restocked (e.g., the item is on backorder or otherwise not available in-store and cannot be easily restocked).

In order to illustrate a method as described herein, consider four operational components layered in sequence by way of non-limiting example. As will become apparent from the following description, each component may be optimized independently, but some embodiments further manage the relationship between the components. In order to demonstrate this example, a plurality of operational components are considered in the following randomized order: in-store product location, assortment, out-of-stock, and planogram.

In Table 1, notice that for in-store location with regard to item A, two stores (07 and 17) are out-of-stock and easily replenished in the main aisle and two stores (11 and 12), are out-of-stock and easily replenished in the endcap. In this situation, in one embodiment, the method may systematically experiment on the impact of placing SKUs at different product locations by replenishing and not replenishing different stochastically equivalent out-of-stock conditions. The method does not require artificial experimentation, but rather the out-of-stock condition naturally occurs in the retail context, and the method can systematically fix or not fix such conditions and observe the operational effect of such actions, thus experimentally determining information about how in-store product location exerts operational effect. By determining the operational effects and applying a resource requirement (e.g., a cost) to each operational component (e.g., taking action to replace an out-of-stock), some embodiments described herein can use queue optimization techniques to determine which out-of-stock conditions return a net positive business value and thus assign operational resource allocation to an operational component. Put another way, retailers may already have out-of-stock conditions occurring and as it is not always possible to fix them all, they make decisions about which ones to fix, but with uncertainty about which out-of-stock conditions are best to fix first. An important technological feature in some embodiments is the layering in of an advanced decision-making process that optimizes knowledge acquisition and business results into this already existing process.

In another aspect, for instance in the context of in-store product location, some embodiments may consider how operational effects may vary overtime. For example, some in-store product locations may have an immediate operational effect (e.g., they may immediately affect a customer's decision whether or not to purchase), while others may have a longer-term operational effect (e.g., a purchase decision may be made on a return visit days after the in-store product location is first seen by a customer). This variation may be represented in some of the embodiments described herein by the temporal reach (e.g., the minimum and/or maximum temporal reach). Thus, some embodiments may take into consideration that if the time course for any particular operational component change varies too quickly, longer-term temporal reach effects will never be measured or taken into account. For this reason, the time course may be varied and experimented upon to find the optimal time course for each operational component (or control signal) pairing with an operational effect.

In a practical implementation of some embodiments herein, the initial control signals for a plurality of operational components may be randomly generated based on parameters of normative operational data (e.g., the system may begin with weights that favor certain actions and situations). As some embodiments begin to gain knowledge, they begin to exploit that knowledge and to customize control signals (e.g., assign operational resource allocations according to the knowledge generation) in order to elicit desirable business impacts (e.g., operational effects). Some embodiments described herein may also monitor for changes in effect over time and dynamically adapt to changing causal relationships.

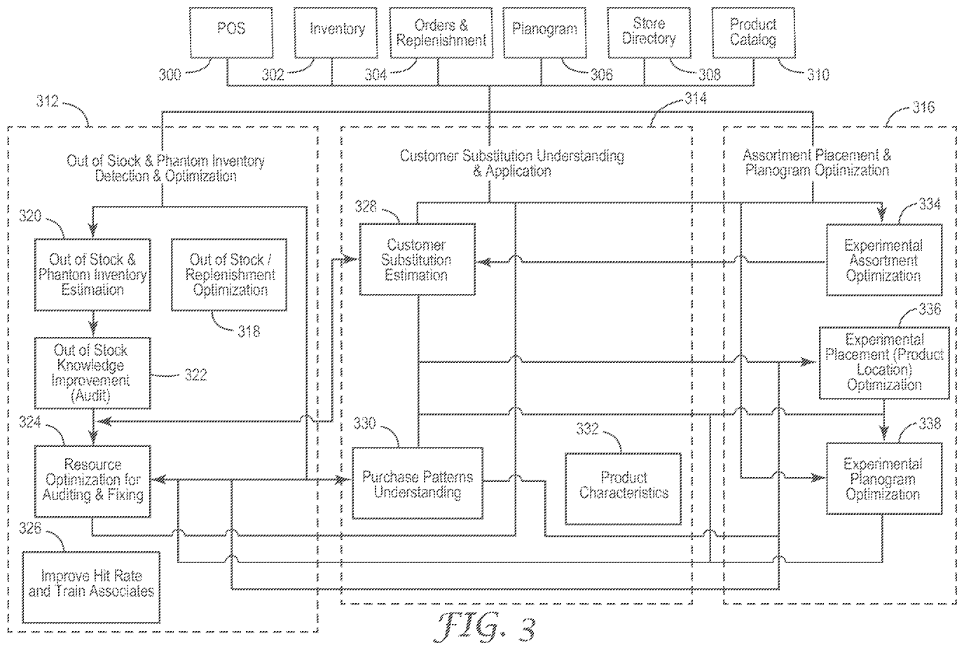

Turning to FIG. 3, various retail processes and associated input data at blocks 300-310 (“associated input data”) and are schematically depicted. At block 300, point of sale data may be utilized as input. Point of sale, by way of non-limiting example, may refer to when/where a purchase is completed. Point of sale data may include date/time of the sale, SKU, location (store location and/or location within store, webpage/app and/or any other data that may be associated with an online transaction), currency, price, payment method, invoice, taxes, and the like. In some embodiments, blocks of data may be generated in a manner in which time blocks may vary stochastically. This may allow for generation and analysis of data within a point of sale or among various points of sale in order to make comparisons with regard to similar and/or different conditions within a point of sale or across points of sale.

At block 302, inventory data may be utilized as an input. By way of non-limiting example, inventory may refer to items/products with respect to SKU basis, SKUs with shared/similar characteristics, per-store basis, multi-store basis (common geography, store type/characteristics, customer characteristics), store inventory levels, wholesaler inventory levels, distributor inventory levels, online inventory levels, and the like. While for the sake of clarity and descriptive ease, some embodiments are described regarding single SKU data, embodiments described herein may operate with regard to data generated across multiple SKUs. This may allow for the generation and exploitation of data regarding a plurality of operational components simultaneously. This may be accomplished by generating, interrogating, and manipulating data relating a single SKU or multiple SKUs. Data from different SKUs can be pooled to allow for benefits described above regarding rapid data set generation and narrow confidence interval determination. Further, data clustering may take into account attributes of different points of sale (e.g., stores) and/or attributes of multiple SKUs, in order to generate data relating to the interaction of those properties. Some embodiments may also use the grouping of SKUs and/or points of sale as an experimental unit to be experimented on with regard to data generation and data analysis.

At block 304, orders and replenishment data may be utilized as an input. Byway of non-limiting example, orders may refer to any request for one or more SKUs by a retailer/store for stock from another source such as a warehouse, another store, or anywhere from which a SKU may be obtained.

Replenishment by way of non-limiting example may refer to one or more orders placed to replace SKUs no longer present or in reduced quantities that may or may not be accurately reflected sales and/or inventory data, wherein replenishment may be in response to sales, donation, disposal, destruction, misplacement, theft, misidentification, and the like.

At block 306, planogram data may be utilized as an input. A planogram, by way of non-limiting example, may refer to a diagram/model indicating retail product placement on shelves, subsection(s) of a store, or an entire store (such as an overhead view of the store layout), including a visual representation/approximation of each product/SKU and quantities. In this way, as SKUs are sold, the appropriate quantity may be utilized to replenish back to the stock levels provided by the planogram.

At block 308, store directory data may be utilized as an input. By way of non-limiting example, directory data may refer to stock/inventory/SKU levels in a retail store on the basis of types of inventory, inventory levels, store map, and the like. At block 310, product catalog data may be utilized as an input. By way of non-limiting example, product catalog data may refer to a database or other collection of data regarding SKUs such as price, dimensions, color, image/video data, reviews, regulatory information, sales trends, location mapping within stores, and/or any other information that may be suitably associated with SKUs.

A first module 312 in this embodiment is directed towards out-of-stock and phantom inventory detection/optimization and may utilize and include out-of-stock/replenishment optimization at block 318, out-of-stock and phantom inventory estimation at block 320, out-of-stock knowledge improvement/audit at block 322, resource optimization for auditing/fixing at block 324, and/or improving hit rate and training associates at block 326. The out-of-stock and phantom inventory detection/optimization of the first module 312 may utilize associated input data, and as described further herein, may provide outputs to and/or receive inputs from the second module 314 and/or third module 316.

A second module 314 in this embodiment is directed towards customer substitution understanding and application and may utilize and include customer substitution estimation at block 328, purchase patterns understanding at block 330, and/or product characteristics at block 332. The customer substitution understanding and application of the second module 314 may utilize associated input data, and as described further herein, may provide outputs to and/or receive inputs from the first module 312 and/or third module 316.

A third module 316 in this embodiment is directed towards assortment placement and planogram optimization and may utilize and include experimental assortment optimization at block 334, experimental placement (product location) optimization at block 336, and/or experimental planogram optimization at block 338. The assortment placement and planogram optimization of the third module 316 may utilize associated input data, and as described further herein, may provide outputs to and/or receive inputs from the first module 312 and/or second module 314.

Turning to out-of-stock/replenishment optimization component at block 318, a significant benefit of improving operational components performance may be provided. Retailers expend significant resources, namely money and employee time, to both maintain available inventory for the SKUs offered to customers and also to reduce the duration of time when SKUs have no available inventory for purchase. In this embodiment, the SKUs offered for sale at any time may constitute the optimal selection. Engaging in the process inhibits acquisition of knowledge about changing customer preferences and reduces the amount of time retailer employees can spend helping customers or doing more valuable tasks. Thus, out-of-stock optimization in embodiments is about computing the relative importance of SKUs being in-stock vs. out-of-stock. For some SKUs, an out-of-stock situation may have a significant negative impact on business results and for other SKUs it may be largely inconsequential. As previously noted, these types of decisions and optimizations are already happening, such that a systemized process may be injected into existing procedures. When a SKU runs out of inventory at a specific store, that product is added to a prioritized queue of all SKUs currently out-of-stock at that store. The out-of-stock operational component may advantageously utilize a short time scale and prioritize the fixing of out-of-stock SKU instances while simultaneously using the instances of fixing out-of-stocks. This, in turn, may be used as an opportunity to use controlled experimentation to assess the degree to which customers will substitute a given SKU (or a collection of SKUs) for other SKUs in the retail environment. The results of the controlled experimentation may then feed recursively into a continuously-updated out-of-stock fixing prioritization process as well as into recommendation and operational systems for continuous improvement in product assortments at the retail locations.

Additionally, it should be noted that in some embodiments, the more stores there are, the more quickly it is possible to collect data points and estimate confidence intervals. Further, blocks/groupings can be formed across time within the same store in order to make comparisons for similar conditions within the store. Moreover, the process does not have to be specific to each individual SKU. Rather it can be generalized to operate across multiple SKUs. This may allow for a general measure of the effectiveness of prioritizing retail components for all SKUs, which may be accomplished by comparing between different SKUs or the same SKUs. Data points for different SKUs can be pooled to estimate confidence intervals more quickly. Clustering can occur based on store attributes and SKU attributes to exploit interactions in those properties.

Put another way, given that out-of-stocks happen, it is not possible to fix them all. Rather than simply fixing them based on standard practices, the opportunity may be utilized to experiment on the value of fixing or not fixing a given out-of-stock condition. Based on multi-objective optimization, control signals (e.g., fix or do-not-fix) across stores or even within stores may vary at different times in order to estimate confidence intervals on the value of fixing or not fixing an out-of-stock situation. Explore and/or exploit may then be utilized accordingly, based on associated confidence intervals. These signals may provide input to customer substitution behaviors and multi-item purchase patterns. Out-of-stock conditions may be used as an opportunity to generate data regarding changes in assortment (e.g., if an item is completely unavailable for purchase in a store). Instead of fixing an out-of-stock condition, such a situation may be used as a control signal regarding the effect of assortment changes, while also fixing the same out-of-stock condition in a different store or at a different time in the same store, to generate a second control signal (a test control signal). In this way, the operational effect of each of these control signals (representing a natural change in the assortment based upon fixing or not fixing an out-of-stock condition) on each of a plurality of operational components can be determined in embodiments. Optionally, confidence intervals may be computed of a causal effect of a presence relative to an absence of a particular control signal (e.g., fix the out-of-stock versus do not fix) within the randomized plurality of control signals on each of the plurality of operational components. Some embodiments may then explore and exploit based upon the confidence intervals. Furthermore, assortment experimentation could be directly or proactively managed, as opposed to awaiting natural out-of-stock conditions, if the opportunity-costs make such experimentation worthwhile. Some embodiments can treat the data from such directly or proactively managed experiments in the same manner as the naturally occurring out-of-stock events are treated.

Out-of-stock and phantom inventory estimation at block 320 may utilize, by way of non-limiting example, associated input data, the resource optimization for auditing/fixing at block 324, the customer substitution data from block 328, and/or the multi-item purchase patterns understanding at block 330. Out-of-stock estimation in some embodiments may be measured as the likelihood of having no available inventory, the difference between measured sales and expected sales and possibly comparisons to current inventory levels. Phantom inventory in some embodiments may be measured as the difference between a currently-expected inventory level and the actual inventory level (i.e., inventory that is believed to be present on the shelf and/or in the store but is not), wherein phantom inventory may be estimated based upon any suitable estimation technique such as historical phantom inventory (corresponding to a store location, time period, shelf location, and the like), confidence interval, and the like. In embodiments, the number of unique SKUs in a store multiplied by the square footage of the store, including the back room, and the vertical shelf space makes the audit and inventory correction process an arduous task; one that essentially cannot be completed in an efficient timeframe. Time spent by employees auditing and correcting inventory results in less of their time spent assisting customers and is thus inefficient.

Out-of-stock knowledge improvement/audit at block 322 may utilize, by way of non-limiting examples, associated input data and/or the out-of-stock and phantom inventory estimation at block 320. Knowledge improvement acquisition (i.e., “explore” goals) may pertain to on-shelf availability, stock levels, phantom inventory, out-of-stock SKUs, and the like. An audit, which may be resource intensive in terms of employee/associate time/labor, may be used to verify and/or update the out-of-stock and phantom inventory estimates received from block 320.

Resource optimization for auditing/fixing at block 324 may utilize, by way of non-limiting examples, associated input data, the out-of-stock knowledge improvement data from block 322, the customer substitution data from block 328, the multi-item purchase patterns understanding at block 330, experimental product location optimization at block 336, and/or the experimental planogram optimization at block 338. At a high level, time spent by employees auditing and correcting inventory results in less of their time spent doing other activities critical to store operations like assisting customers. One embodiment relates to a method for allocating operational resources to operational components comprising selecting a plurality of operational components to which operational resources may be allocated.

Assigning a resource allocation to an operational component may include assigning resources (peoples' time and product) to restock an out-of-stock instance. In such situations, some embodiments may specify the resource allocation level to be so assigned. In the instance of replenishing an out-of-stock instance, for example, this may involve specifying how many units of a product to stock in a given out-of-stock location rather than providing a simple binary option of replenish or do not replenish. When specifying how many units of a product to stock, some embodiments may take into consideration optimization goals (e.g., weighing the operational resource allocation cost against an operational component goal). Some embodiments may also take into consideration factors such as historical sales rates. In another aspect, some embodiments may consider a balancing of knowledge acquisition goals (i.e., explore) and operational goals (i.e., exploit), for restocking out-of-stock SKUs in a manner that is likely to lead to a future out-of-stock condition within a desirable timeframe such that additional information may be gathered about how such out-of-stock instances affects other operational components.

In another aspect, when allocating resources to an operational component includes assigning resources (e.g., employee time, product, and the like) to restock an out-of-stock instance, some embodiments may generate data as well as operational resource allocation suggestions for product assortment. Regarding assortment, some embodiments may provide improved data regarding the value of having a SKU within a selection of SKUs for a given category. When a product is out-of-stock, the situation may be considered a naturally-occurring experimental instance of assortment change, such that a customer may encounter an assortment that excludes the out-of-stock item. When data such as sales information is considered during a time period when an item is in-stock versus a time period when an item is out-of-stock, some embodiments may generate additional data regarding the effects of such changes in assortment. Such additional data include, by way of non-limiting examples, sales (as such effects may be, one will understand, not just the effects of sales within the category of SKUs that are in or out-of-stock (such as customer substitution behaviors)) as well as other product categories (multi-item purchase patterns and the like).

As multiple operational components may be involved, multi-objective optimization may be utilized to simultaneously optimize each of the operational components by minimizing confounds between them. For example, confounds may be removed through Latin-square counter-balancing or any other suitable method known to one of ordinary skill in the art. In this way, pure knowledge may be generated about product location optimization and assortment optimization independently and in how they relate to each other. Referring back to Table 1, it illustrates how to generate and use data from naturally occurring out-of-stock instances and the cost of allocating resources among many operational components in order to prioritize operational resource allocation among operational components.

Continuing with the example, returning to item G in Table 1, data may be generated independently about both assortment and in-store product location. This may include, for instance, the effect that each has on the sales of item G and/or items that are purchased with or substituted for item G, for which there may be multiple out-of-stock conditions across all stores, and all of which may be replenished based upon the data. For example, stores 07 and 20 are completely out-of-stock, stores 03 and 06 are out-of-stock in the main aisle only, and stores 14 and 16 are out-of-stock in the endcap only. Stores 07 and 20 may generate direct experimental data regarding assortment while simultaneously providing data regarding in-store product location. Stores 03, 06, 14, and 16 are not completely out-of-stock, so they do not present a natural opportunity to generate data regarding assortment, but they none-the-less provide an opportunity to generate data (by fixing or not fixing the out-of-stock instances) regarding in-store product location. Thus, within the context of such natural experimentation, it may, in some embodiments, be advantageous to include multiple points of sale (e.g., stores) in order to collect data more rapidly and to reduce uncertainty by more quickly generating a larger data set.

Turning to block 326, improving the accuracy of identifying when SKUs are out-of-stock and fixing the out-of-stock instance (hit rate) and training associates may assist with determining whether it is worth improving the “hit rate” of replenishing an out-of-stock SKU. This may be directly or proactively managed, as opposed to awaiting natural out-of-stock conditions, if the opportunity-costs make such experimentation worthwhile. For example, a retailer may define constraints on how and when fixing out-of-stock happens (e.g., always fix out-of-stocks for certain SKUs, fix out-of-stock instances only during specific time periods) as well as constraints on resources and employee time (e.g., employees cannot be interrupted when helping a customer).

Turning to customer substitution understanding and application in the second module 314, customer substitution estimation at block 328 may implement the substitution operational component and utilize, by way of non-limiting examples, the out-of-stock knowledge improvement/audit at block 322 and/or the experimental assortment optimization at block 334. Customer substitution estimation in some embodiments may be measured as the difference between measured sales and expected sales of a first set of one or more SKUs in comparison with expected sales of a second set of one or more other SKUs (when the second set is in-stock). In some embodiments, customer substitution may pertain to knowledge of what product a customer is likely to substitute in the event their desired product is unavailable. Customer substitution knowledge in some embodiments is very valuable to the prioritization of the queue of what SKUs to audit and what inventory to correct. By identifying those SKUs least likely to be substituted by the customer, the retailer knows that if those SKUs are unavailable, they are likely to lose sales. Prioritization can therefore be given to those SKUs least likely to be substituted by the customer to ensure that such SKUs are available, along with correcting the inventory when such SKUs are found to be unavailable. Those SKUs that are more likely to be substituted by the customer may be placed lower in the audit queue if the inventory of the substitution products are available, however this adjustment in the audit queue should consider the effects of not offering specific SKUs on other operational components and optimization goals. When both a product and the substitution product are unavailable, the retailer may prioritize correcting the inventory of the primary product, or the substitution product, or neither product. However, correcting the other product may be deprioritized with the knowledge that if the substitution product is available, the customer is still likely to make a purchase.

Utilizing the substitution operational component, the accuracy and robustness of estimated customer substitution probabilities may be improved and thereby reduce the likelihood of false positives (i.e., estimating some substitution when none occurs) and false negatives (i.e., estimating no substitution when some occurs). In some embodiments, naturally occurring out-of-stock conditions may be used to compute confidence intervals regarding customer substitution. Such confidence intervals may, in some embodiments, be computed based on the causal effect of a presence relative to an absence of a particular control signal (fix the out-of-stock versus not fixing it) within a randomized plurality of control signals utilized upon each of the plurality of operational components. Explore (i.e., exploring unchartered territory or attempting to acquire new knowledge, without regarding to optimize benefit from existing knowledge) and exploit (i.e., utilizing existing knowledge to optimize decision making without regard to acquiring new knowledge) options may be utilized based upon confidence intervals to optimize attempts to thus balance reward maximization based on the knowledge already acquired with attempting new actions to further increase knowledge (i.e., balancing these competing interests to maximize their total value over the period of time considered). Customer substitution estimation may be directly or proactively managed, as opposed to awaiting natural out-of-stock conditions, if the opportunity-costs make such experimentation worthwhile. Data from such directly or proactively managed experiments may be treated in the same manner as that of the naturally occurring out-of-stock events.

In some embodiments, the substitution operational component improves the accuracy and robustness of estimated customer substitution probabilities while also reducing the likelihood of false positives (estimating some substitution when none occurs) and false negatives (estimating no substitution when some occurs). These improvements translate into better estimates of the value of offering specific SKUs at specific stores over time. In some embodiments, the substitution operational component also advantageously decreases uncertainty that is specific to confounding variables that could cause natural temporal variations in sales to be misinterpreted as customer substitution behavior. The substitution operational component may also help identify those SKUs in which the value of replenishing inventory is greater than not doing so and thus empowers retailers to prioritize SKUs both when performing an audit and acting on the results.

As also discussed further in the context of assortment optimization, customer substitution may be estimated as the difference between measured sales and expected sales of SKUs {ABC} relative to expected sales of SKUs {XYZ} when {XYZ} cycle between in-stock and out-of-stock. There is no control in some embodiments over which SKUs {XYZ} are cycled and for how long they remain in-stock or out-of-stock, thus estimated substitution behavior may be confounded in numerous ways. Put another way, estimated substitution behavior may be masked due to the lack of control over which SKUs are cycled and the duration they are in/out-of-stock. Sets of SKUs at one store may often be unavailable at the same time, and therefore substitution between these SKUs cannot be estimated. SKUs can frequently run out of inventory because customer demand spikes for many SKUs, and for SKUs that remain available substitution may be estimated to be larger because sales are higher. For example, some SKUs with small physical form factors and/or low demand cannot be replenished in isolation because one replenishment order severely underutilizes the volume available on a single shipping pallet or container, so these SKUs must wait for replenishment orders for other SKUs at the same store before new inventory can be delivered. This type of supply chain constraint may extend the out-of-stock period duration for small form factor SKUs and can dilute, mar, or otherwise confound evidence of customer substitution to other SKUs.

Quasi-experiments, from which substitution behaviors may be inferred, may be further constrained in terms of statistical power by the desire of the retailer to maintain inventory for all SKUs as often as possible so that the in-stock periods are longer than the out-of-stock periods. Armed with knowledge of substitution behaviors, retailers may further prioritize the highest-selling SKUs to receive new inventory replenishment as often as necessary, such that some SKUs at some stores may seldom or never go out-of-stock even if customers are willing to substitute to other SKUs.

Performance of the operational components may also be enhanced by reducing the distorting effect of natural confounds on estimated customer substitution behaviors that drive specific assortment changes. A constantly-changing set of time periods when specific SKUs are in-stock and out-of-stock may be treated as a population from which similar subsets should be selected and corrections should be applied to more accurately determine how customers would respond to assortment changes. These estimated customer responses to assortment changes may be used to determine which SKUs should be offered and to drive permanent assortment changes described herein. Inventory replenishment and assortment change recommendations may be prioritized by estimating whether specific actions will reduce confounding biases, and by how much. Exactly why subsets should be selected and why corrections should be applied are fundamental consequences in some embodiments of dynamic consumer purchase behaviors and retailer store inventory management systems. By way of non-limiting example, a small specific set of products {X} at specific stores {G} are unavailable for purchase only on Sundays because nearly all customers interested in that set {X} make purchases primarily on Fridays and Saturdays. If sales of most products {Y} excluding {X} at stores {G} often rise above their local averages on Sundays independent of the availability of products {X}, then this natural rise may be a confounding variable that would erroneously increase both the estimated probability of customers purchasing SKUs from {Y} in place of {X} and the estimated value of offering products in {Y} and not offering products in {X}.

Store-specific cycles in which SKUs oscillate from in-stock to out-of-stock and return to in-stock states are foundational in some embodiments. Initially, these cycles may occur randomly due to lags between dynamic customer purchase decisions and inventory replenishment, and the temporal duration of in-stock and out-of-stock periods within each cycle is uncontrolled. Each cycle for a specific item X may constitute a quasi-experiment whereby customer preferences to substitute an item Y in place of X may be inferred based on the change in sales of Y conditional on the state (in-stock or out-of-stock) of X and other variables. Building on the customer substitutions estimated from quasi-experiments, continuous active experimentation by the operational components may be utilized to control the initiation, duration, and termination of these cycles by tactically removing or adding on-shelf inventory and withholding inventory replenishment. In some embodiments, each controlled cycle for a specific item X constitutes a true experiment, and the data captured within each cycle may be used as it was previously from quasi-experiments to estimate customer substitution behaviors. Regardless of how the cycles occur (controlled or uncontrolled), the estimated customer substitution behaviors may be affected by confounding biases that matriculate into potentially large distortions in the estimated value of offering, or not offering, each item by store. In the context of retail assortment optimization and customer substitution behavior estimation in some embodiments, there are multiple sources of confounding bias and numerous methods to estimate and minimize these biases.

In some embodiments, primary sources of confounding bias affecting customer substitution behavior estimation are dynamic customer demand multi-item purchase patterns driving SKUs out-of-stock and dynamic inventory replenishment cycle patterns driving SKUs out-of-stock. Customer-demand-based multi-item purchase pattern-driven confounding bias may manifest as natural variations in product sales caused by customer demand multi-item purchase patterns that coincide with time periods when specific SKUs cycle between in-stock and out-of-stock. A specific example of this is described herein with specific SKUs at certain stores being out-of-stock on Sundays, and other SKUs at the same stores selling above their average rate on Sundays. Replenishment cycle driven confounding bias primarily affects the duration of in-stock and out-of-stock periods that are used to estimate substitution behavior in some embodiments. A specific non-limiting example of replenishment driven confounding bias is a product R at one store running out of inventory but inventory replenishment not being ordered until several days later. Here, replenishment is not ordered immediately for product R because the desired order case pack count of the inventory replenishment order is physically too small to fit on the smallest divisible unit of one shipping pallet, and the replenishment order is thus delayed until another product S at the same store runs out of inventory and needs replenishment. The replenishment for SKUs S and R can be packaged together and meet the minimum physical size requirement for shipping. This specific confound in this non-limiting example may inhibit the estimation of customers substituting product S in place of R, the effects the estimates of customers substituting other SKUs in place of R by extending the period when R is unavailable, and may increase the probability that customers substitute with the same SKUs when either R or S are unavailable. Both replenishment-driven bias and consumer-demand-driven bias can dilute or magnify customer substitution estimates, and there are several methods to estimate and minimize these biases.

In some embodiments, estimating and reducing the effect of confound bias on customer substitution estimates can be done simultaneously, but the approach to both differs if the confounding variables are known and measurable versus unknown and/or cannot be measured accurately. If the confounding variables are known and measurable, then in-stock and out-of-stock time periods that take the same values of confounding variables can be grouped together to negate the effect of different confounding variable values. Alternatively, if the cycle between in-stock and out-of-stock is systematically controlled (i.e., true experiments, not quasi-experiments, are being run), then these cycles can be generated uniformly over all values of known confounding variables. Having sufficient randomization of the sample size will negate the effect of known confounding variables. By way of non-limiting example, inventory for certain products may only be delivered to a store on weekdays (Monday through Friday) and these products periodically are out-of-stock on weekdays and weekends. When these products are unavailable on a Friday, it is very likely that they will remain out-of-stock until the following Monday, at the earliest. Using the grouping method, the time periods when products are out-of-stock on weekends should only be compared to time periods when those products are in-stock on weekends, and similarly for weekday periods. If the confounding variables are known but not measurable or poorly measured, or there exist additional unknown confounding variables, then grouping and randomization cannot enable estimation or reduction of the biases they induce. To estimate and reduce bias from unknown or difficult-to-measure confounding variables, the fundamental responses (e.g., sales over time for each item by store) may be modeled as a function of measurable independent variables that are expected to co-vary with the response variables (item sales) and may exclude the control signal variables (i.e., which SKUs are available and unavailable). In this embodiment, this method effectively seeks to estimate what sales of each item would have occurred naturally if there was no change in availability/unavailability of other SKUs. These expected sales can then be subtracted from the actual sales to better estimate the variation in sales of one item conditional only on the availability of another item. Biases induced by confounding variables such as the amicability and availability of store employees to help customers and daily foot traffic to stores can be estimated and reduced by this modeling approach and provide value in auxiliary ways that further improves customer behavior estimation.

The matching of in-stock periods with out-of-stock periods is a challenging problem in some embodiments, but one that can be simplified using the modeling method of confounding bias estimation and reduction described herein. Although the cyclic nature of item availability implies that there is often an in-stock time period adjacent to an out-of-stock time period for the same item, the retailer may be systematically interested in maintaining inventory for all SKUs and minimizing the duration of out-of-stock periods. As a result, the duration of in-stock periods on average may be much longer than the duration of out-of-stock periods, and the period characteristics (e.g., weather, store total sales volume, fraction of time on weekends, proximity to the end of a month, existence of temporary sales promotions, and the like) may differ significantly between in-stock and out-of-stock periods and bias the estimates of customer substitution behaviors. To better match in-stock and out-of-stock periods so that an accurate estimate of customer substitution may be obtained, the predicted sales of the item cycling between in-stock and out-of-stock should be similar across the matched time periods in some embodiments. This approach may also expedite the matching process by negating the need to cluster time periods together based on numerous variables of different data types (factor, numeric, and the like) that may or may not have a material effect on item sales.

In some embodiments, experiments in real stores where assortments are changed based on estimated customer substitution behavior provide a powerful, real-world feedback mechanism to improve internal and external validity of confound bias estimates and reduction methods. Confounding variables may be identified through a combination of domain knowledge, inferential statistics, and machine learning methods. Moreover, the bias that confounding variables induce in customer substitution behaviors may be overestimated or underestimated by various embodiments described herein. Dynamically changing in-store assortments where confounds are observed may provide opportunities to iteratively refine estimates of confounding bias and methods to reduce bias by comparing what is expected to what is observed after changing assortments. These comparisons can be recursively fed back into embodiments used to estimate confounding bias as part of an inferential system, such as a partially observed Markov decision process, to better align estimates of confounding bias to observations.

Another advantage in some embodiments of the substitution operational component involves using the estimates of confound bias as a function of confounding variables to drive towards optimal generation of in-stock/out-of-stock cycles over time across all SKUs and stores. Given any set {G} of measurable variables that are expected to confound customer substitution estimation, the magnitude of confounding bias induced by each variable g in {G} may be enormous during some period of time and negligible during a different period of time for one set of SKUs at specific stores. In embodiments, the variation in confound bias estimates over time will feed into item availability and assortment optimization recommendations to increase in-stock/out-of-stock cycles, where confound bias is estimated to be large and have large uncertainty, and decrease in-stock/out-of-stock cycles where confound bias is estimated to be small with small uncertainty. Advantageously, this reduction in confound bias magnitude and uncertainty will contribute to the total value of recommending specific assortment changes and replenishing or not replenishing inventory for unavailable SKUs.

Multi-item purchase pattern understanding at block 330 may utilize, by way of non-limiting examples, associated input data, the resource optimization for auditing/fixing at block 324, experimental placement (product location) optimization at block 336, and/or the experimental planogram optimization at block 338. The multi-item purchase patterns operational component may estimate probabilities of customers buying specific SKUs together and thereby increase knowledge of which SKUs customers will and will not purchase together and how those multi-item purchase patterns relate to out-of-stock situations. The multi-item purchase patterns of customers in some embodiments may be very valuable to the prioritization of audit and inventory correction queues. Knowing which SKUs are frequently purchased together, the retailer can prioritize the queues of both SKUs in order to continue servicing the customer. Conversely, deprioritizing those SKUs that are purchased independently impacts only those SKUs and not the sales of other SKUs in the store in some embodiments. As discussed herein, multi-item purchase patterns do not have direct constraints.

In embodiments, the multi-item purchase patterns operational component utilizes strategies to estimate the probabilities of customers buying specific SKUs together. SKU purchase patterns may be provided as an input into the overall planogram assortment of specific SKUs and as a feedback loop to the purchase pattern probability estimates. By way of non-limiting example, SKUs commonly purchased together can be moved within their respective planograms to test whether the purchase pattern is sensitive to the amount of visible inventory capacity and relative product placement.

As discussed herein, multi-item purchase patterns affect the primary sources of confounding bias affecting customer approaches. This may typically include dynamic customer demand multi-item purchase patterns driving SKUs out-of-stock and dynamic inventory replenishment cycle patterns driving SKUs out-of-stock. Customer demand-based multi-item purchase pattern driven confounding bias may manifest as natural variations in product sales caused by customer demand-based multi-item purchase patterns that coincide with time periods when specific SKUs cycle between in-stock and out-of-stock. A non-limiting example of this is described with respect to the substitution operational component regarding specific SKUs at certain stores being out-of-stock on Sundays, and other SKUs at the same stores selling above their average rate on Sundays.

In another example, the multi-item purchase patterns operational component may advantageously increase knowledge of which SKUs customers will and will not purchase together and how those multi-item purchase patterns relate to out-of-stock situations. By way of non-limiting example, if customers always buy SKU Y with SKU X and if SKU X is out-of-stock, then customers will not buy SKU Y that is in-stock. It should also be noted in this embodiment that the min/max temporal reach of multi-item purchase patterns represents the estimated minimum and maximum amount of time that estimated multi-item purchase pattern probabilities are accurate representations of true customer multi-item purchase patterns across multiple SKUs.

The operational components may use the various out-of-stock conditions to compute confidence intervals on multi-item purchase patterns not only naturally/organically but also to intentionally fix or not fix out-of-stock situations in ways that better inform regarding multi-item purchase patterns. Such confidence intervals may be computed of a causal effect of a presence relative to an absence of a particular control signal (fix the out-of-stock versus do not fix) within the randomized plurality of control signals on each of the plurality of operational components. Explore and exploit may be utilized based upon the confidence intervals. Multi-item purchase patterns could be directly or proactively managed, as opposed to awaiting natural out-of-stock conditions, if the opportunity-costs make such experimentation worthwhile. Data from such directly or proactively managed experiments may be treated in the same manner as it treats the naturally occurring out-of-stock events.

Product characteristics at block 332 may be utilized by the customer substitution understanding and application of the second module 314 and may refer to, by way of non-limiting examples, (i) how frequently SKUs are involved in customer substitution, either as a SKU intended for purchase or a SKU being substituted and/or (ii) the frequency of a SKU being included in an assortment. Identifying, by way of non-limiting example, two SKUs frequently purchased together allows for the prioritization of the queues of both SKUs in order to continue servicing the customer while also deprioritizing those SKUs that are purchased independently, which thus only impacts those independently-purchased SKUs and not the sales of other SKUs.

Turning to assortment placement and planogram optimization in the third module 316, the goal for experimental assortment optimization at block 334 in some embodiments is not to correct all the out-of-stock inventory, but to correct that inventory where the benefit of doing so is greater than the value of not replenishing the inventory by decreasing uncertainty specific to product assortment. This uncertainty may surround which SKUs have greater value in correcting the inventory and the extent to which retailers incorrectly identify those SKUs is detrimental to commerce. Thus, in some embodiments, assortment optimization is about the value of having something in the store vs. not having it in the store.

With assortment optimization, decisions may be made about which SKUs should be available in different stores. In some respects, it may be regarded as a special case of product location optimization such that locations within a store are treated as all or nothing. In addition, where product location optimization is about the value of different locations for the same SKU, in embodiments, assortment optimization is about the value proposition across different SKUs. As a queue optimization process integrated into a process that is already in place, not all SKUs are offered in all stores and when out-of-stocks happen at a store level (completely unavailable at all product locations), so these situations cannot all be fixed. In some embodiments, they must be prioritized and resolved in a particular order. Some embodiments may integrate a decision-making system into that existing process.

For any given product in a retailer's assortment, the true inventory may be more, less, or equal to the value the store's data presents. Reconciling the difference between the data and the store's true inventory may be done by performing an audit in which employees count the number of SKUs in the store at a given location. Once an audit is complete, any number of SKUs may have been identified as having a discrepancy between what the store believed was the inventory prior to the audit, the true inventory after the audit, and the ideal inventory for a product in that location. The inventory is then corrected. As discussed herein, when the inventory is listed as being in-stock but not on the shelf may be referred to as phantom inventory, which may be considered a subset of on-shelf availability.

Product assortment may be rationally optimized in the context of multiple operational components to manage the priorities and rationalize the relationships optimizing the singular goal. The assortment operational component in some embodiments measures and optimizes the value of offering different mixes and combinations of products (i.e., assortments) within a retail store. Observational data may be utilized to make causal inferences of the impact of specific SKUs being out-of-stock on the sales of other SKUs at the same store. This may be performed via natural quasi-experiments where products {XYZ} cycle between in-stock and out-of-stock due to dynamic customer demand and inventory replenishment, in order to measure the sales of products {ABC} during those cycles and compare measured sales to expected (model predicted) sales if products {XYZ} had not experienced any cycles.

Customer substitution may then be estimated as the difference between measured sales and expected sales of {ABC} relative to expected sales of {XYZ} when in-stock. In some embodiments, there is no control over which products {XYZ} cycled and for how long they remain in-stock or out-of-stock, so estimated substitution behavior may be confounded in numerous ways. Put another way, estimated substitution behavior may be masked due to the lack of control over which products are cycled and the duration they are in/out-of-stock. Sets of products at one store are often unavailable at the same time, and therefore substitution between these products cannot be estimated. Products can frequently run out of inventory because customer demand spikes for many products, and for products that remain available substitution may be estimated to be larger because sales are higher. Some products with small physical form factors and low demand cannot be replenished in isolation because one replenishment order severely underutilizes the volume available on a single shipping pallet or container, so these products must wait for replenishment orders for other products at the same store before new inventory can be delivered. This supply chain constraint may extend the out-of-stock period duration for small form factor products and can dilute, mar, or otherwise confound evidence of customer substitution to other products.

Quasi-experiments, from which substitution behaviors may be inferred, may be further constrained in terms of statistical power by the desire of the retailer to maintain inventory for all SKUs as often as possible for the in-stock periods to be longer than the out-of-stock periods. Retailers may further prioritize the highest selling SKUs to receive new inventory replenishment as often as necessary, so some SKUs at some stores may seldom or never go out-of-stock even if customers are willing to substitute to other SKUs. The dimensionality of the environment being studied through quasi-experiments is enormous in embodiments and may include by way of non-limiting examples geographic location, types of SKUs, customer tendencies, replenishment dynamics, seasonal trends, and the like. This in turn may make it very difficult in some embodiments to control the distribution of observations (quasi-experiments) across these dimensions. The assortment operational component in this embodiment builds upon such natural quasi-experiments and may add new technical abilities, such as controlling the duration of out-of-stock and in-stock periods through store employee interventions. Other technical abilities may include continuously integrating new hypotheses based on business knowledge and estimated customer substitution behaviors, as well as more efficiently acquiring and exploiting customer behavior knowledge to drive towards more optimal assortments at each store.

Put another way, the experimental assortment optimization at block 334 may utilize associated input data and/or the customer substitution estimation at block 328, to treat product assortment optimization as one among various operational components (e.g., out-of-stock optimization, product location optimization, substitution optimization, multi-item purchase patterns, and/or planogram optimization) and to treat their interrelationships as a queue optimization problem and experiment, whereby adaptive randomized controlled trials on the allocation of operational resources within and across are directed across the operational components. These adaptive randomized controlled trials may be utilized to explore and exploit the causal structure of the problem-spaces of each individual operational component and their interrelationships. This may also improve outcomes within the operational components in a way that may rationalize and improve the allocation of resources across and within the individual operational components.

Regarding experimental placement (product location operational component) optimization at block 336, in-store product location may be rationally optimized in the context of multiple operational components, to manage the priorities and rationalize the relationships optimizing the singular goal. More specifically, the product location operational component may measure and/or optimize the value of placing SKUs at different locations within a retail store (e.g., a product can be placed within a planogram in an aisle, in an aisle endcap, at a checkout line, on a spindle in an aisle, or the like).

Experimental placement (product location operational component) optimization at block 336 may utilize, by way of non-limiting examples, associated input data, the customer substitution data from block 328, and/or the multi-item purchase patterns understanding at block 330 to capture existing knowledge and best practices for location of SKUs within a store in order to measure and/or optimize the value of placing SKUs at different locations within a store. A further embodiment may generate data regarding the effects of in-store product location. By way of non-limiting example, an out-of-stock condition may arise within a store at a single location for an item that is offered for sale at multiple locations within a store. Such an out-of-stock condition may present an opportunity to conduct an experiment by choosing to either fix or to not fix the out-of-stock condition at the relevant location. Fixing may involve replenishing from overhead stock, from backroom stock, ordering new inventory, or it may involve moving SKUs from one location in a store to another so that no single location is out-of-stock. Some embodiments may use various control signals (e.g., fix or do not fix) as control signals with regard to in-store product location across different stores, or even within a single store or multiple stores at different periods of time. Optionally, confidence intervals may be computed regarding a causal effect of a presence relative to an absence of a particular control signal (fix the out-of-stock versus do not fix it) within the randomized plurality of control signals on each of the plurality of operational components. Some embodiments may then explore/exploit based upon the confidence intervals. Furthermore, in-store product location experimentation may be directly or proactively managed, as opposed to awaiting natural out-of-stock conditions, when the opportunity-costs make such experimentation worthwhile. Some embodiments may treat the data from such directly or proactively managed experiments in the same manner as it treats the naturally occurring out-of-stock events.

In some embodiments, experimental placement optimization rolls out queued product location changes through continuous, iterative adjustment based on multi-objective optimization, which may be employed to enable adaptive experimentation on the impact of the product assortment changes through a balance of causal knowledge acquisition and driving improved business results. Traditionally, the goal of determining the business value of candidate SKU locations would tend to be dealt with independently via various standard methods. For example, analysts would examine the sales rates, or profit margins of each of the SKUs, including possibly customer choice modeling, and/or creating statistical/mathematical models that would then be used to generate predictions about the business impact of the SKUs being placed at different candidate locations. Then, they would prioritize the locations with the highest predicted business impact. Typically, each SKU has the same universal product code (UPC)/barcode/QR code regardless of where it is placed in the store, such that the purchases may be recorded at the point-of-sale/checkout after the SKUs have been removed from their original location. This creates an attribution problem that greatly complicates standard methods of analysis and measurement.

A way to determine these answers for certain (i.e., the values of different product locations) would be to execute a randomized controlled experiment (analogous to a clinical drug trial). By way of non-limiting example, the retailer could randomly assign some stores at certain times to have the product located at different candidate locations and observe the impact of those location manipulations on actual business performance. However, executing such product location experiments would be resource intensive, and even if they were executed and optimal policies were validly determined at time T for all stores, it would be impossible to know if those policies are still optimal after time T given at least (i) the dynamic nature of business retail conditions, (ii) constantly-changing market conditions, and (iii) constantly-changing customer behaviors. Instead of using either of these approaches (modeling observational data or executing experiments to drive later policy decisions), as discussed herein, the product location operational component may be integrated into store operations to advantageously execute one continuous adaptive product location clinical trial.

While it might seem that the integration of the product location operational component would greatly increase the complexity of retail operations, for example, the opposite is true because the embodiments described herein are designed to integrate into the spaces where existing retail operations already operate with uncertainty. For example, out-of-stocks at certain product locations happen regularly and cannot all be fixed or might be fixed in different ways, leaving employees to make their best judgment amid uncertainty. Instead, integrated into these uncertainty spaces, the product location operational component may provide direction to employees of what to do in practical terms while continuously providing behind the scenes the benefits of an adaptive clinical trial. By using randomized controlled experiments, the entire process may become recursive, constantly improving, and knowledge-generating while simultaneously improving business results. In some embodiments, no longer does the retailer lose the ability to learn the absolute value of whether and where a product should be in the store due to continuously following the same patterns. Instead, by naturally integrating the resolution of each question, the retailer simultaneously discovers, learns, and makes a difference to their business.

Once an audit is complete, as discussed herein, some SKUs may be identified as having a phantom inventory discrepancy between what the store believed was the inventory prior to the audit, the true inventory after the audit and the ideal inventory for a product in that location. This discrepancy in some circumstances may be corrected based on a larger system of adaptive clinical trial experiments. The number of unique SKUs in a store multiplied by the square footage of the store, including the back room, and the vertical shelf space typically the audit and inventory correction process presents an arduous task in which time spent by the sales associates auditing and correcting inventory results in less of their time spent assisting customers. Therefore, the goal in this embodiment is not to correct all the out-of-stock inventory, but only to correct that inventory where the benefit of doing so is greater than the value of not replenishing the inventory. The uncertainty surrounding which SKUs have greater value in correcting the inventory and the extent to which retailers incorrectly identify those SKUs is detrimental to commerce. Embodiments of the product location operational component can decrease that uncertainty specific to product locations. It identifies those product locations where the value of replenishing the inventory is greater than not doing so and empowers retailers to prioritize product locations both when performing an audit and acting on the results.

The product location operational component may introduce new embodiments for the management and prioritization of the queue of product locations to leverage and maintain. Performing active experimentation on these product locations may improve the behavior of the management and prioritization by feeding the results, for example, into the substitution operational component and/or multi-item purchase patterns operational component, two key operational components to producing the queue in some embodiments. The same experimentation and feedback embodiments may also be applied to the queue for the correction of inventory discrepancies, although these may not be solely responsible for the improvement of out-of-stock inventory. The data collected from the experimentation and the improvements to substitution and multi-item purchase patterns knowledge are fundamental in some embodiments to improving the assortment of SKUs not only at a store, but at specific product locations within a store. The knowledge surrounding assortment, substitution, and purchasing patterns can all be improved by taking different actions at different stores under the same out-of-stock conditions.

Returning to the GW/SW non-limiting example, the focus here is on product location optimization. Initially, these SKUs have the following possible product placements, which may be hard constraints:
(i) GW can be placed: 1) within a planogram in aisle 3; 2) in an endcap on aisle 6; or 3) at the checkout line.
(ii) SW can be placed: 1) within a planogram in aisle 7; 2) on in a spindle in aisle 8; or 3) at the checkout line.
(iii) Only one of GW or SW can be placed at the checkout line, not both.

Each of the locations can be eliminated, whereby there is literally no space for the product at that location. The primary goal of the retailer is to determine the business value of having each of the SKUs available at their candidate locations. By way of non-limiting example, the retailer may determine (i) which SKU provides the most value at the checkout and/or (ii) how the value of the respective planogram placements compares to that of the checkout. In this embodiment, this goal is relevant during the initial placement of SKUs at given locations to decide if a placement should be set up at all. However, SKUs may intermittently go out-of-stock at different product locations, as is common in retail. When this happens, employees take valuable time to keep product locations in-stock, considering that they have limited time and may need to prioritize certain locations over others.

As discussed herein, optimization goals may define which business outcomes should be maximized and/or minimized. In the context of the product location operational component, the optimization goal in some embodiments is to maximize the business impact of having versus not having a SKU available at a set of locations in a store such that, given the store level assortment of the SKUs, any change in location of the SKUs in a store category would result in a reduced business outcome. Business outcomes may be measured using various figures-of-merit such as: currency sales per day per store, unit sales per day per store, gross profit per day per store, and the like. Any other suitable variations of figures-of-merit are available in other embodiments to those of ordinary skill in the art.

As described herein, constraints may be utilized to describe parameters for control signal assignments/activities that are allowed/disallowed. Constraints may also describe the bounds of uncertainty in current operational processes. Retailers in some embodiments may have long-established practices and procedures for determining product locations in-store, but many of these decisions are made amid uncertainty. In this embodiment, identifying this uncertainty may be crucial, as this is where the optimization opportunity may lie. Subject matter experts may or may not be aware of this uncertainty. In this embodiment, it may be important to identify the hard constraints that the system cannot violate (e.g., only one of SW and GW can be placed at the checkout). However, it can also important not to over-constrain the system by carefully differentiating true hard constraints from normative best practices or soft constraints.

Regarding product location in this embodiment, constraints once identified may be managed in two primary ways. In the first way, subject matter experts (such as human operators of the product location operational component) may entirely manage the identification and honoring of constraints outside of the system proper. This may be accomplished via subject matter experts carefully specifying the independent variables (which are further discussed herein) in ways that honor the required constraints. In this embodiment, the product location operational component does not have to know explicitly about the constraints. In the second way, constraints may be codified into the product location operational component such that it can enforce those rules. Configuring the location operational component with those constraints can be accomplished through different means. In one example, a user can manually enter each constraint in explicit form. In a different example, using any suitable algorithm, the product location operational component might generate options for product location changes and have those confirmed or denied by the user. In yet another example, the product location operational component may analyze past product location configurations to infer constraints, wherein any combination of these examples may be utilized.

As discussed in embodiments herein, normative operational data may capture the standard/best practices that currently exist in retail operations. For product locations, normative operational data may be utilized to capture the existing knowledge and best practices for locations of SKUs within a store. For example, taking as a hard constraint that GW and SW cannot both be placed at the checkout, what do best practices and existing knowledge say about which product should be placed at checkout? If subject matter experts believe that GW is more effective at the checkout in general, this belief can be quantified and used by the product location operational component to guide decisions. For example, if subject matter experts are 80% confident that GW is the best choice for checkout, some embodiments may therefore allocate GW to the checkout 80% of the time and SW only 20% of the time.

As further discussed herein, the combination of constraints and normative operational data may help to clarify and define the independent variables, which may be limited by the constraints, and they can be influenced or initialized by the normative operational parameters. As discussed further herein, in some embodiments it may also be highly beneficial to define independent variables with independent variable levels that cover a wide range of the possible search space, rather than independent variable levels that only vary in subtle ways, which may create more space for optimization. Initial application of independent variable levels can be weighted based on normative operational data, they may be randomized, or can be assigned through other mechanisms. It may also be highly beneficial for independent variables to be orthogonal such that one set of independent variable levels can be applied in any combination with independent variable levels from other independent variables. However, this is not always possible in various embodiments, depending on the constraints. Hard constraints may restrict certain independent variable levels from appearing in combination together, prevent certain independent variables and independent variable levels from being used at certain stores, and the like. In this embodiment, such hard constraints should be avoided as much as possible to maximize the broad application of independent variables and independent variable levels. As described herein, these constraints may be managed by the subject matter expert, codified in the product location operational component, or a mix of both.

In the context of product location, min/max temporal reach represents in embodiments the estimated minimum and maximum amount of time that customers will react to product location changes, such as adding a SKU to or removing a SKU from a particular location within a store, by way of non-limiting example. As discussed further herein, the min/max spatial reach may be used to bound and subsequently optimize spatial spillover effects. In the context of product location, min/max spatial reach represents the extent, if any, to which changes at one product location may impact or spillover into optimization goals measured from another product location in the same store or other stores.

The product location operational component utilizes adaptive experimentation as a technical solution over traditional, prescriptive experimentation, as the product location operational component rolls out queued product location changes through continuous, iterative adjustment based on multi-objective optimization. Product location changes may be identified and prioritized as part of the overall experimental queue optimization mechanism. Multi-objective optimization may be employed to enable adaptive experimentation on the impact of the product location changes through a balance of causal knowledge acquisition and driving improved business results. It is important to note the technological advantage that embodiments are integrated into existing operations where there is already uncertainty, and in this way, do not add burdensome impacts to existing retail operations. Product location changes are already made today, often based on human judgment and intuition. The goal in some embodiments is to inject multi-objective optimization into these processes to derive true causal knowledge that may then be leveraged to increase business results.

Returning to the interrelation of the operational components, the product location operational component utilizes inputs for the management and prioritization of the queue of product locations to leverage and maintain. Performing active experimentation on these SKUs' availability as a function of confounding variables improves the behavior of management and prioritization by feeding the results into the substitution operational component and multi-item purchase patterns operational component, which in embodiments are two key components to producing the queue in some embodiments. The same experimentation and feedback methods may also be applied to the queue for the correction of the inventory discrepancies. These methods are not solely for the improvement of out-of-stock inventory in some embodiments. The data collected from the experimentation and the improvements to substitution and multi-item purchase patterns knowledge are fundamental in some embodiments to improving the assortment of SKUs not only at a store, but at specific product locations within a store (i.e., product location optimization). The knowledge surrounding assortment, consumer substitution, and purchasing patterns can all be improved by taking different actions at different stores under the same out-of-stock conditions.

In this embodiment, queue optimization may operate in spaces where action already needs to be taken and there is uncertainty as to what the best action is. Instead of simply taking what seems like the best course, the opportunity may be taken to experiment, which in embodiments inherently results in experimenting in the search space areas where there is ambiguity and, importantly, avoids experimentation in areas that do not require it. By way of non-limiting example, across many stores GW is placed at the checkout and it is out-of-stock with some consistency. Put another way, it sells out frequently but store associates fail to replenish it regularly, and/or there is no further stock is available to replenish it. Instead of simply replenishing GW at all the stores (assuming that is possible in such embodiments), the product location operational component can experiment. Some stores may have the checkout replenished with GW, some may have the checkout replenished with stores with SW, some stores with neither, inclusive of any combination thereof. In this way, the product location operational component can form a causal estimate of the impact of each widget (e.g., GW or SW) at the checkout. For example, if at the same time SW is nearly always in-stock in the planogram or product location because it rarely sells from there, there can be less-frequent experimentation because there are fewer out-of-stock situations to respond to.

Adaptive experimentation may be smaller scale and more customized. In embodiments, product location changes executed are typically small and quick to implement in some embodiments. Also, changes may be implemented organically in a few stores at a time, rather than being executed in a coordinated fashion across hundreds or thousands of stores. Over time, small product location changes that create demonstrated business value across stores may be implemented broadly. However, many product location changes might become idiosyncratic to small groups of stores, such that the product location operational component may naturally explore the search space and may settle on both global and/or local optimums.

Experimental planogram optimization at block 338 may utilize, by way of non-limiting examples, associated input data, the customer substitution data from block 328, the multi-item purchase patterns understanding at block 330, and/or the experimental placement optimization at block 336. In some embodiments, a planogram may be regarded as an arrangement of SKUs on a retail shelf. Each product may be given a certain number of facings (placements at the shelf edge) and the shelf may be generally, if not always, filled. Put another way, a planogram may be regarded as a physical structure within which SKUs may be placed upon different levels/shelves, effectively governing the amount of inventory space visible to the customers and the arrangement of those SKUs relative to each other. The amount of customer-visible inventory space allocated to each product can be “facings” on a shelf, hanging pegs on a board, or any other suitable unit. Planogramming in embodiments may include broader concerns such as overall product assortment, supply chain, and the like. In embodiments, planogramming may involve multiple complex factors such as customer purchase and decision patterns, market basket analysis, visual arrangement and customer visual attention probabilities, overall bay or module width, past sales performance, etc. In this embodiment, the planogram operational component may operate within the context of arrangement of SKUs in a physical structure, like a multi-shelf case, endcap or peg board, given the physical structure and a set of candidate SKUs that can be included. Other aspects of planograms may be managed by subject matter experts or incorporated into adaptive experiments and planogram optimization.

In this embodiment, it is typical for planograms to be non-optimal and there is a spectrum of exploration required. For example, an organization may define a single “average” planogram and employ it in all stores, based on mean-store performance. However, such an average planogram may only be optimal for average stores and fail to perform as well for other stores where customers desire a set of SKUs that differs from the average planogram. On the other extreme, planograms can be defined independently for each store, but this takes a huge effort and still does not make it easy to find optimal configurations. The planogram operational component described herein may solve and optimize this problem, all while providing several real-world benefits. First, the planogram operational component may naturally help reduce out-of-stocks, understocks, and overstocks of SKUs given the proper independent variable and independent variable level definitions through adaptive micro experimentation. Second, the planogram operational component may iteratively explore the search space of possible planograms in a low-cost fashion. Third, the planogram operational component may naturally emphasize exploration in problem-areas of the search space, which are inherently more likely to lead to greater improvements. Fourth, the planogram operational component may react to changes over time regarding which planogram configuration is most optimal for a given store.

In this embodiment, retailers may seek to determine the business value of offering each SKU in a specific location within a planogram. Based on this information, the retailer can attempt to determine the mix of SKUs for each store or set of stores that will maximize overall business value. This goal may be very relevant during the initial selection of SKUs for a given store, i.e., to decide what mix of SKUs the store should start with. However, as time passes, customer preferences change, new SKUs become available, existing SKUs are discontinued, and various other changes may take place. Planogram optimization is therefore not merely a static problem, but rather an on-going challenge.

The traditional goal of determining the business value of offering each SKU in a specific planogram configuration would tend to be dealt with independently via various standard methods. As discussed similarly herein with respect to other operational components, the best way to determine the value of specific planograms may be to run randomized controlled trials to acquire causal knowledge of the effects of planogram changes on business performance.

Thus, experimentation may initially start randomly in some embodiments based on the parameters of normative operational data (e.g., beginning with weights that favor certain actions and situations). As knowledge is gained, that knowledge may be exploited and control signals customized to different situations to increase business value and impact. Embodiments also may monitor for changes in effects over time and dynamically adapt. It is important to note that embodiments do not simply assign a product location that is out-of-stock to be replenished, but rather specify how many units to stock at that location. Based on estimated sales rates, embodiments may then optimize how quickly out-of-stocks reoccur. Depending on time course, optimization goals, and knowledge acquisition goals, it is often optimal to only partially replenish product locations and let them go out-of-stock again sooner, rather than later.

An embodiment of experimental planogram optimization may generate data regarding the effects of planogram design, such as how an out-of-stock condition may arise within a store at a given location within a planogram. Such an out-of-stock conditions may present an opportunity to conduct an experiment by choosing to either fix or to not fix the out-of-stock condition. Fixing may involve replenishing from overhead stock, from backroom stock, or it may involve moving SKUs from one location in a store to the empty location in the planogram. Some embodiments may use various control signals (e.g., to fix or to not fix) as control signals with regard to planogram design across different stores, or even within a single store, at different periods of time. Confidence intervals may be computed regarding a causal effect of a presence relative to an absence of a particular control signal (to fix or to not fix) within the randomized plurality of control signals on each of the plurality of operational components. Some embodiments may then explore and exploit based upon the confidence intervals.

Furthermore, planogram experimentation may be directly or proactively managed, as opposed to awaiting natural out-of-stock conditions, if the opportunity-costs make such experimentation worthwhile. Some embodiments may treat the data from such directly or proactively managed experiments in the same manner as it treats the naturally occurring out-of-stock events.

In some embodiments, there are mechanisms provided by the planogram operational component for optimizing planograms based on the measured impact in business terms using causal inference and knowledge. The planogram operational component may improve planograms based on real-world results. In embodiments, planogram optimization may be regarded as a specialization of product location optimization to encompass the spatial positioning of a product within a given location that considers visual attention and acuity. Particularly using adaptive micro experimentation, the planogram operational component in embodiments naturally settles on optimality in an efficient fashion, avoiding other more difficult and costly approaches. The planogram operational component may embrace the local customization of planograms to experiment upon and achieve improved overall results. Feedback mechanisms may enable continuous optimization and adaptation to change.

In embodiments, the planogram operational component is transformative for the planogramming process through its ability to efficiently find more optimal planograms amid uncertainty and existing complex processes. This, in combination with the other operational components described herein, may enable improvement in business performance that can be substantial when aggregated across stores and/or time. By way of non-limiting example, one research and development experiment resulted in a five percent increase in sales for one product category. This experiment had 16 different planograms in 150 randomized test stores over a three-month period. This resulted in a process change with a vendor, rather than retailer, explicitly dictating the assortment at the shelf at the retailer's store(s). Thus, each store's assortment and planogram may be specified using cause and effect on business performance as the mechanism, rather than the common practice of a line review and “gut feel” and flawed regression and/or store-by-store, year-over-year analysis.

In some embodiments, while observational data may be utilized to generally make causal inferences of the impact of specific SKUs being out-of-stock on the sales of other SKUs at the same store, the planogram operational component may provide control over which SKUs {XYZ} cycle through and for how long they remain in-stock or out-of-stock, so that the estimated substitution behavior avoids being confounded in numerous ways. In some embodiments, sets of SKUs at one store are often unavailable at the same time, and therefore substitution between these SKUs cannot be estimated. SKUs frequently run out of inventory in such embodiments because customer demand spikes for many SKUs, and for SKUs that remain available substitution is estimated to be larger because sales are higher. Some SKUs with small physical form factors and low demand cannot be replenished in isolation because one replenishment order may severely underutilize the volume available on a single shipping pallet or container, such that these SKUs must wait for replenishment orders for other SKUs at the same store before new inventory can be delivered. This supply chain constraint may be regarded as extending the out-of-stock period duration for small form factor SKUs and can dilute/mar evidence of customer substitution to other SKUs.

In this embodiment, any quasi-experiments from which substitution behaviors are inferred would be constrained in terms of statistical power by the desire of the retailer to maintain inventory for all SKUs as often as possible, for example the in-stock periods will naturally be longer than the out-of-stock periods. Often, retailers prioritize the highest selling SKUs to receive new inventory replenishment as often as necessary, such that some SKUs at some stores may seldom (or even never) go out-of-stock, even if customers are willing to substitute to other SKUs. The dimensionality of the environment studied through quasi-experiments can be enormous, by way of non-limiting examples including geographic location, types of SKUs, product locations in each planogram and inventory space allocations, customer tendencies, replenishment dynamics, seasonal trends, and the like. In embodiments, it may be impossible to control the distribution of observations (via quasi-experiments) across these numerous dimensions. Thus, as a significant improvement, the planogram operational component in embodiments adds abilities to control the duration of out-of-stock and in-stock periods through store employee interventions to continuously integrate new planogram design hypotheses based on business knowledge and estimated customer substitution behaviors, and to more efficiently acquire and exploit customer behavior knowledge to drive towards more optimal planograms at each store.

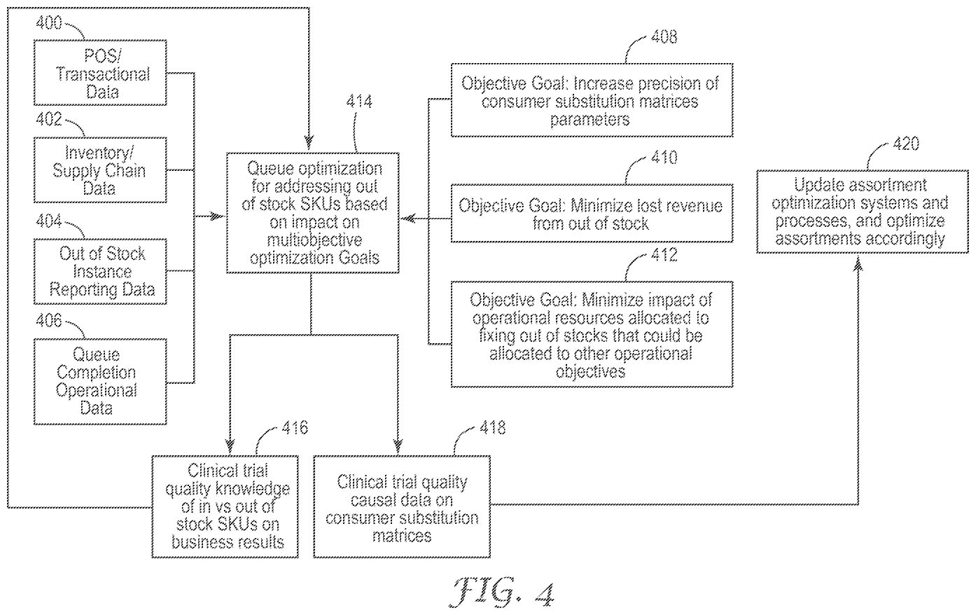

Turning to FIG. 4, a flow diagram schematically illustrates an embodiment for optimizing item availability and assortment in which SKUs that are out-of-stock may be prioritized in a queue to be fixed (i.e., receive new inventory). This may be applied in embodiments in which retailer employees are alerted and dispatched to replenish inventory for specific unavailable SKUs. Various types of data may be utilized by the out-of-stock operational component. Point of sale and/or other transactional data may be obtained at block 400. Inventory and/or supply chain data, which may include on-shelf availability data by way of non-limiting example, may be obtained at block 402. Out-of-stock instance reporting data may be obtained at block 404, which may include by way of non-limiting example, reported instances of a particular SKU being out-of-stock by a retail employee or customer. Queue completion operational data may be obtained at block 406, which may include by way of non-limiting example, replenishing (or fixing) out-of-stock SKUs with additional stock available elsewhere in the store.

There may be several exemplary queue optimization goals, such as increasing the precision of customer substitution matrices parameters at block 408. By way of non-limiting example, when a product at a store runs out of inventory, there are often other similar products that customers could buy instead. The likelihood of that product substitution occurring, and the cost or benefit of that substitution, may be important components of the overall utility of replenishing a given item. Here, the probability of customers substituting from any one product or group of products X to other products may be estimated by comparing the actual sales of other products when X is unavailable to the expected sales of other products over the same time periods had X been available. An example substitution matrix is shown here in Table 2:

TABLE 2

| unavailable | substitute | substitute | substitute | substitute | substitute | substitute | substitute | Avg no |
|---|---|---|---|---|---|---|---|---|
| product | to A (%) | to B (%) | to C (%) | to D (%) | to E (%) | to F (%) | to G (%) | purchase (%) |
| A | 0 +/− 0 | 6 +/− 2.7 | 4 +/− 1.6 | 6 +/− 1.9 | 14 +/− 3.4 | 14 +/− 4.2 | 10 +/− 3.5 | 46 |
| B | 12 +/− 1.8 | 0 +/− 0 | 4 +/− 1.4 | 14 +/− 2.1 | 18 +/− 1.2 | 25 +/− 2.4 | 18 +/− 2.4 | 9 |
| C | 10 +/− 1.4 | 12 +/− 3.3 | 0 +/− 0 | 18 +/− 2.1 | 12 +/− 2.7 | 14 +/− 3 | 32 +/− 5.3 | 2 |
| D | 10 +/− 2.7 | 2 +/− 0.5 | 5 +/− 2.7 | 0 +/− 0 | 4 +/− 1.5 | 22 +/− 3.6 | 18 +/− 3.8 | 39 |
| E | 2 +/− 0.9 | 6 +/− 0.3 | 3 +/− 1.6 | 4 +/− 0.8 | 0 +/− 0 | 25 +/− 2.2 | 14 +/− 1.6 | 46 |
| F | 2 +/− 1 | 0 +/− 0 | 2 +/− 0.6 | 0 +/− 0.5 | 4 +/− 1.5 | 0 +/− 0 | 8 +/− 2.4 | 84 |
| G | 0 +/− 0 | 0 +/− 0 | 2 +/− 0.6 | 2 +/− 0.5 | 4 +/− 1.2 | 14 +/− 3.5 | 0 +/− 0 | 78 |

Table 2 provides customer substitution probabilities between seven products (A-G) at a store. The average value of customers substituting from one item to other possible options is shown here in Table 3:

TABLE 3

| | | average substitution |
|---|---|---|
| product | price ($) | product price ($) |
| A | 1.5 | 2.85 |
| B | 2.1 | 4.71 |
| C | 3.2 | 4.99 |
| D | 4 | 3.24 |
| E | 5.51 | 2.97 |
| F | 6.1 | 0.90 |
| G | 7.35 | 1.22 |

Table 3 provides product sale prices and average price of substitution options, where the price of no purchase is set to $0. The average price of substitution options is calculated as the price of other products that customers can substitute as weighted by their respective substitution probabilities listed in Table 2.

At block 410, another goal may be to minimize revenue loss from out-of-stocks. Put another way, when a SKU is out-of-stock, a customer cannot purchase it, which may directly lead to a loss of the revenue that could have been realized had the SKU been in-stock when the customer was at the store ready to purchase the SKU. At block 412, another goal may include minimizing the operational impact when fixing out-of-stock situations. By way of non-limiting example, a real-time alert system could be used to notify employees about which SKUs should be replenished when the current expected benefit of offering the product exceeds the current expected cost of replenishing inventory for that SKU. While the benefit of offering a product is that customers can buy it, the costs of replenishing inventory can be manifold. Employee resources may still be required to replenish inventory and their time could instead be spent helping customers. Thus, saving employees from having to unnecessarily replenish out-of-stock SKUs provides a tangible and significant real-world advantage in terms of resource allocation.

At block 414, the data inputs from blocks 400-406 may be utilized for queue optimization to address out-of-stock SKUs, subject to any suitable combination of, for example, the objective goals in blocks 408-412. When a SKU runs out of inventory at a specific store, then that product may be added to a prioritized queue of all SKUs that are currently out-of-stock at that store. Queue optimization may be based on impact upon the multi-objective optimization goals discussed herein, as between any combination of the out-of-stock operational component, the assortment operational component, the product location operational component, the planogram operational component, the substitution operational component, and the multi-item purchase patterns operational component, by way of non-limiting example.

The net value of fixing out-of-stock instances, and thus the order of the prioritized queue, may fluctuate over time within each day and across multiple days based on many factors, including by way of non-limiting examples, customer foot traffic and availability of other SKUs. If, for example, the number of customers in need of assistance is small relative to the number of employees who are available to help customers or replenish inventory at a shelf, then the cost of replenishing inventory for any single product is likely small and some out-of-stock SKUs will be replenished. Alternately, during time periods when there are many more customers seeking help than employees available to help, many out-of-stock SKUs may not have an alert enabled because customers may be willing to substitute to other SKUs that remain available, and the expected cost of an employee's time exceeds the expected benefit of offering the product to customers, thus (for example) helping to meet the goal in block 412 of minimizing the impact upon operational resources.

At block 416, the effect of clinical trial quality knowledge of in-stock versus out-of-stock SKUs on business results may be determined. For example, once an assortment change is implemented, the removed product(s) may be treated as permanently unavailable, and substitution probabilities and uncertainties may be further refined as new sales data is acquired. The actual performance of the new assortment may be compared to expectations to drive to more accurate estimates of the value of making assortment changes, such as recursively providing these results to the queue optimization back to block 414.

At block 418, regarding customer substitution behaviors as further discussed with respect to the substitution operational component, the effect of clinical trial quality casual data on customer substitution matrices may be determined. Returning to Table 2, for some SKUs, like B and C, customers may trade up to higher price SKUs and this benefits sales, while for other SKUs, like E and F, customers substitute nothing or to lower price SKUs, to the detriment of sales. Replenishing SKU inventory allows customers to buy the SKU they seek, and in the case of SKUs like E and F this is beneficial, but this replenishment nevertheless has two negative consequences. First, it requires employee resources that could be spent on customers. Second, it reduces the amount of data available to collect on the out-of-stock instance, resulting in more uncertainty around customer substitution behavior.

Using data from these substitutions to produce a distribution of probabilities, the value of offering each product inclusive of the other SKUs that customers may purchase as substitution options (i.e., mean values in Table 3) may be calculated directly. In some embodiments, the value of not offering a SKU that is currently out-of-stock critically depends on the uncertainties around the probabilities of customers substituting other SKUs for their first-choice SKU. The larger the substitution uncertainties, in embodiments, the larger the uncertainties are around the expected value of removing an unavailable product completely, and the greater the value of not replenishing inventory for an unavailable SKU. By allowing a SKU to remain unavailable, more data to characterize substitution is collected, and the substitution uncertainties are driven lower. Methods such as Monte Carlo sampling or any other suitable technique known to those of ordinary skill in the art may be used to quantify the effect of reducing substitution probability uncertainties in monetary terms by emulating what purchase behaviors would be expected in historical data when specific SKUs are unavailable and customer decisions are driven by the estimated substitution probabilities, such as the example in Table 3.

Once a substitution probability matrix is estimated, the relative value of offering and not offering each product may be calculated. From these value estimates, specific assortment changes may be recommended and implemented in real stores. The value of removing one SKU or SKU group {X} and adding a different set may be calculated based on probabilities that customers substitute from {X} to all other SKUs, the difference in business value (revenue, profit, etc.) from selling {X} versus selling other SKUs, and/or the expected probability of customers not substituting to any other product. New assortments that are expected to perform better than the existing assortments, inclusive of setup costs, may be implemented in stores. The cost of implementing a new assortment at a store may include factors like the value of retailer employee time to setup the new SKUs, the value of inventory for SKUs that will no longer be offered and must either be discarded or sold at a discount, the cost of reconfiguring shelves, and/or the like.

At block 420, assortments may be updated and optimized based upon the causal data at block 418. This process of driving assortment changes based on customer substitution behavior and using the data collected after making assortment changes to recursively update substitution estimates is one of many possible ways to improve retailer business performance.

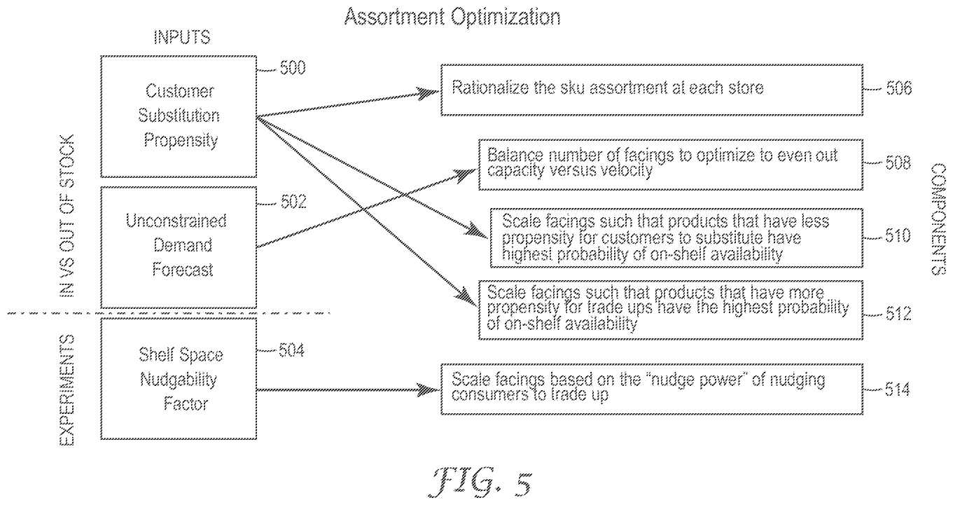

Turning to a view of assortment optimization in FIG. 5, a diagram schematically illustrates assortment optimization inputs in blocks 500-504 and assortment optimization components in blocks 506-514. One exemplary assortment optimization input, in the context of SKUs being in-stock vs out-of-stock, is customer substitution propensity at block 500. As discussed further with respect to the out-of-stock and substitution operational components, a substitution matrix (see Table 2) may relate to an estimated probability of customers substituting from any product (or group of SKUs X) to other SKUs by comparing actual sales of other SKUs when X is unavailable to the expected sales of other SKUs over the same time periods had X been available.

At block 502, another exemplary assortment optimization input, in the context of SKUs being in-stock vs out-of-stock, may be unconstrained demand forecast. In one embodiment, this may refer to the forecasted demand by customers for one or more SKUs (up to an entire assortment) without regard to constraints (such as hard/soft constraints from other operational components) such as known out-of-stock SKUs. In another embodiment, unconstrained demand forecast may be an upper bound of demand applied to any number of SKUs (ranging from a single SKU to an assortment of all SKUs in a store to all possible SKUs) based upon forecasted range of demand.

At block 504, another exemplary assortment optimization input, in the context of running clinical-trial experiments as discussed herein, may be physical space nudgability factor, which may be relevant in any physical location where a SKU is offered. In this embodiment, nudgability may be considered the ability of SKU facings (e.g., shelf space or the like) to influence (or nudge) a customer towards taking a certain action. By way of non-limiting example, the number facings on a shelf for a first SKU may increase the likelihood (i.e., nudge) a customer will purchase the SKU based on the number of facings it has.

A first component of assortment optimization at block 506 may be to rationalize the SKU assortment at each store. Utilizing customer substitution propensity at block 500 as assortment optimization input, the assortment of inventory may be optimized based upon customer substitution matrices in determining which SKUs customers are likely to substitute for other SKUs.

A second component of assortment optimization at block 508 may be to balance the number of facings to even-out capacity versus velocity. Utilizing the unconstrained demand forecast at block 502 as an assortment optimization input, an optimal number of facings may be utilized to avoid having too many SKU facings (high capacity requiring too much queue velocity in terms of replacing SKUs as they are sold) or too few SKU facings (not enough on-shelf capacity thereby reducing sales).

A third component of assortment optimization at block 510 may be to scale facings such that SKUs for which customers have less propensity to substitute away from have the highest probability of on-shelf availability. Utilizing customer substitution propensity at block 500 as assortment optimization input, this may help ensure the greatest on-shelf availability of those SKUs that customers are least likely to not buy (by substituting for another SKU to purchase instead).

A fourth component of assortment optimization at block 512 may be to scale facings such that SKUs that have more propensity for trade ups have the highest probability of on-shelf availability. Utilizing customer substitution propensity at block 500 as assortment optimization input, this may help ensure the greatest on-shelf availability of those SKUs for which customers are most likely to trade-up for another SKU (such as a higher-margin SKU).

A fifth component of assortment optimization at block 514 may be to scale facings based on the nudge power of nudging customers towards a goal, such as trading up to another SKU. Utilizing the shelf space nudgability factor at block 504 as assortment optimization input, an optimal number of SKU facings may be utilized to nudge customers towards another desired SKU, where having too many or too few facings of the SKU may decrease sales of the SKU.

In some embodiments, the assortment operational component may treat product assortment optimization as one among many operational components such as out-of-stock optimization, product location optimization, and planogram optimization. Their interrelationships may be regarded as a queue optimization problem and experiment, in order to direct adaptive randomized controlled trials on the allocation of operational resources within and across the operational components. Such adaptive randomized controlled trials may be utilized to explore and exploit the causal structure of the problem-spaces of each individual operational component and their interrelationships. This in turn may improve outcomes within the operational components and rationalize and improve the allocation of resources within and across the individual operational components. The broader structure and interplay of experimentation of these operational components is described with respect to FIG. 3.

Byway of non-limiting example, there may be a set of 150 stores, each with hundreds of SKUs. Some SKUs may be offered at all 150 stores while other SKUs may only be offered in a few stores. In this way, each store may have its own unique assortment of SKUs. However, there are likely to be many commonalities in assortments at different stores (this commonality is not strictly required in this embodiment, it is just the common mode of operation for retailers). The primary goal of the retailer in some embodiments may be to determine the business value of offering each of the SKUs as part of the product assortment. Based on this information, the retailer can attempt to determine the mix of SKUs for each store or set of stores that will maximize overall business value. This goal may be very relevant during the initial selection of SKUs for a given store, such as deciding what mix of SKUs the store should start with. However, as time passes, customer preferences change, new SKUs become available, existing SKUs are discontinued, and various other changes may take place. Assortment optimization in various embodiments therefore remains an on-going challenge.

As discussed herein, constraints may be used to describe parameters for control signal assignments/activities that are allowed or disallowed. Constraints also describe the bounds of uncertainty in current operational processes. Retailers may have long-established practices and procedures for determining product assortments, but many of these decisions are made amid uncertainty. Identifying this uncertainty may be crucial as this is where the optimization opportunity lies in various embodiments. Subject matter experts may or may not be aware of this uncertainty. It is important in embodiments to identify the hard constraints that cannot be violated (e.g., SKU A must be offered in all stores). However, it may also be important at the same time not to over-constrain the system by carefully differentiating true hard constraints from normative “best practices”. A consideration in that non-limiting example may be whether SKU A should be omitted from the assortment in rare cases.

As with other operational components, once identified, assortment optimization constraints may be managed in two primary ways. First, subject matter experts as human operators of the system may entirely manage the identification and honoring of constraints outside of the system proper. This may be accomplished by subject matter experts carefully specifying the independent variables in ways that honor the required constraints. In this embodiment, the operational components do not have to know explicitly about the constraints. Second, constraints may be codified into the system such that it can enforce those rules. Configuring the system with those constraints can be accomplished through different means. Non-limiting examples include: (i) users can manually enter each product assortment constraint in explicit form, (ii) options for product assortment changes can be generated and then confirmed or denied by the user, and (iii) past product assortment data can be analyzed to infer constraints.

As discussed herein, normative operational data may be used to capture the standard/best practices that currently exist in operational components and are believed to best achieve the optimization goals. These normative practices may serve as the starting point for execution such that implementation may be made to change existing operations only gradually, and drastic change is not required. For the assortment operational component, normative operational data may capture the existing knowledge and best practices for the mixes and quantities of SKUs to offer within a store. For example, given limited shelf space, the determination may be what best practices and existing knowledge say about which SKUs should and should not be offered to meet customer demand.

The combination of constraints and normative operational data may help to clarify and define the independent variables, wherein the system is free to change and manipulate associated parameters/conditions. The independent variables in this embodiment are limited by the constraints, and they can be influenced or initialized by the normative operational parameters. Independent variables in this non-limiting embodiment essentially codify the underlying hypotheses about what scenarios will increase or inhibit business results. Hypotheses drive the discovery of causal knowledge leading to optimization and improved performance. Depending on how the constraints are managed (as discussed above), hypotheses and independent variables may be entirely defined by subject matter experts, formulated by the system itself, or a combination of the two.

As discussed herein, the definition of independent variables can lead to a large search space for experimentation that may be prohibitive for full exploration in some embodiments. In this case, hypotheses can be refined and prioritized based on, by way of non-limiting examples: (i) subject matter expert knowledge and judgment, (ii) descriptive data analysis, (iii) known customer substitution behaviors to drive richer customer substitution behavior knowledge, and/or (iv) known multi-item purchase pattern behaviors to drive richer multi-item purchase pattern behavior knowledge. These hypothesis refinement methods may or may not keep a human-in-the-loop.

In some embodiments, it is generally most beneficial to define independent variables with independent variable levels that cover a wide range of the possible search space, rather than independent variable levels that only vary in subtle ways. This approach may create more space for optimization. Initial application of independent variable levels can be weighted based on normative operational data. It is also highly beneficial for independent variables to be orthogonal such that one set of independent variable levels can be applied in any combination with independent variable levels from other independent variables. However, this is not always possible, depending on the constraints. Constraints may restrict certain independent variable levels from appearing in combination together, prevent certain independent variables and independent variable levels from being used at certain stores, etc. Such constraints should be avoided as much as possible to maximize the broad application of independent variables and independent variable levels. As described herein, these constraints may be managed by the subject matter expert, codified in the system, or a mix of both.

Byway of non-limiting example, the subject matter expert may hypothesize that SKU A should be offered in all stores and SKU B should only be offered at a few stores. However, the subject matter expert may be uncertain about this hypothesis, as one hypothesis may hold that SKU A and SKU B are interchangeable in terms of business value, while another hypothesis may hold that SKU B drives more value at certain subsets of stores than SKU A. These hypotheses can be evaluated by defining independent variables for the inclusion or exclusion of SKUs A and B in the product assortments.

Min/max temporal reach in the context of assortment optimization represents, in this embodiment, the estimated minimum and/or maximum amount of time that customers will react to product assortment changes (e.g., adding a SKU to or removing a SKU from a particular store). This is because min/max temporal reach may be used to bound and subsequently optimize temporal carryover effects. Temporal carryover may happen when the business impacts of actions taken in a time epoch bleed over into subsequent time epochs. For example, customers may respond to changing retail conditions (e.g., changes to assortment) over the course of multiple visits, such that the effects may not be immediate. Min/max temporal reach may account for this by estimating how long in time effects will be measurable in terms of optimization goals.

Regarding min/max spatial reach in the context of assortment optimization, in this embodiment it represents the extent if any to which changes in product assortment at one store may impact or spillover into optimization goals measured at other stores. This is because minimum and/or maximum spatial reach may be used to bound and subsequently optimize spatial spillover effects. Spatial spillover may happen when the business impacts of actions taken in one spatial region bleed over into adjacent spatial regions. For example, customers may visit multiple nearby stores but the effects may not be limited to a single store. Min/max spatial reach of the assortment across multiple stores may account for this by estimating how far in space effects will be measurable in terms of assortment optimization goals.

The assortment operational component may utilize adaptive experimentation as a technical solution over traditional, prescriptive experimentation, which carries a few essential drawbacks for which different independent variables may be experimented on in a relatively controlled fashion over time. Regarding the disadvantages of the traditional, prescriptive experimentation approach, there may be many independent variables resulting in a long time spent exploring the search space. Moreover, traditional, prescriptive experimentation fails to fully leverage domain knowledge and established best practices that may already result in overall good performance. As an additional disadvantage, results found during a time epoch may not translate to another epoch and it may therefore be difficult to even detect that this is the case. In this embodiment, it is important to note by contrast that the assortment operational component may be integrated into existing operations where there is already uncertainty. In this way, the assortment operational component may provide an important improvement that does not add burdensome impacts to existing operational components. Product assortment changes are already made today, often based on human judgment and intuition. One goal in this embodiment is to inject multi-objective optimization into these processes to derive true causal knowledge that is then leveraged to increase business results.

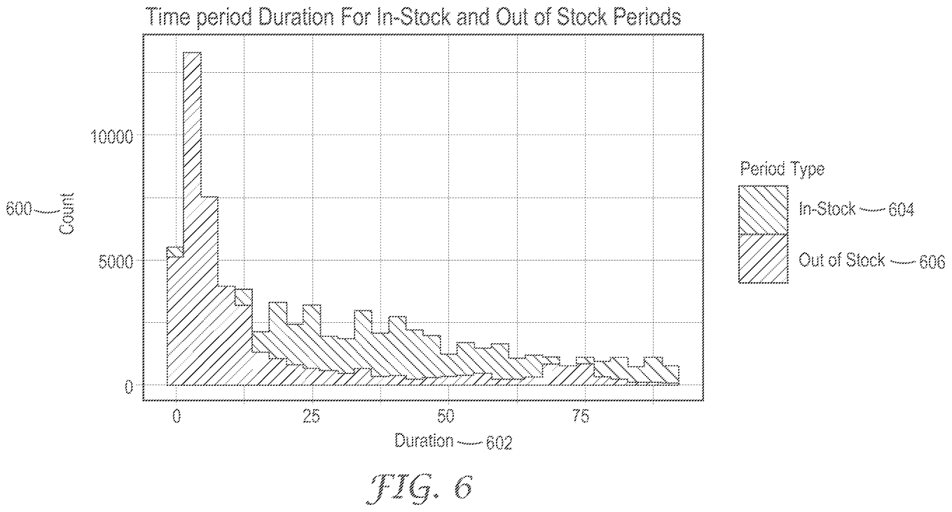

Turning to FIG. 6, a graph of a time period duration for in-stock and out-of-stock periods is depicted. In this non-limiting example, the count 600 (or quantity) of a SKU (for a given store, group of stores, region, territory, and the like) over the course of a duration 602 (which may be measured in hours, days, weeks, months, or any suitable increment of time). The period types may include quantities of the SKU that are in-stock 604 and quantities of the SKU that are out-of-stock 606. Put another way, this graph may provide a view over a period of time of how much of the SKU was in-stock and how much of it was out-of-stock. In some embodiments, the typical out-of-stock period is significantly shorter than the typical in-stock period.

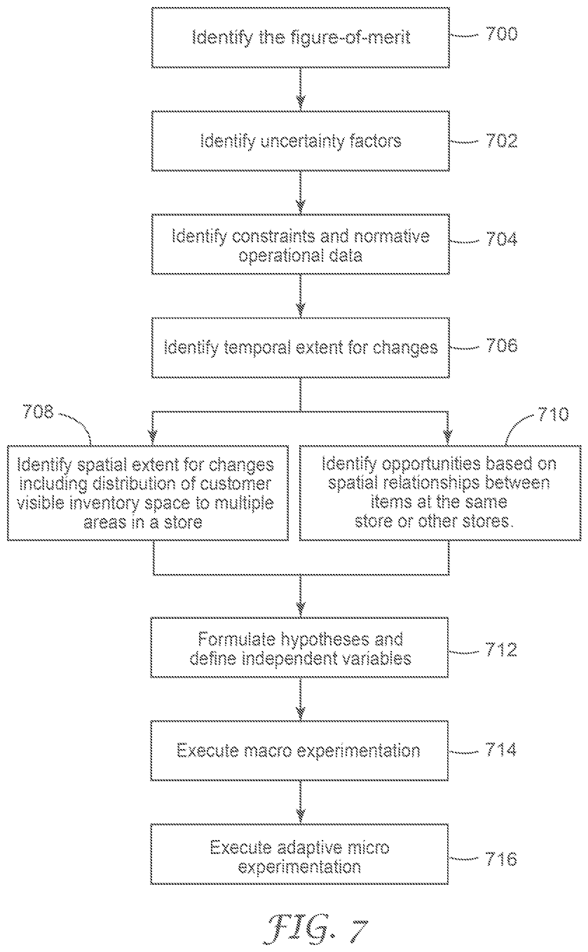

Turning to FIG. 7, a flow diagram illustrates a method utilized in one embodiment by the planogram operational component to optimize retail planograms. At block 700, a first operation in this embodiment may be to identify the most meaningful business metric by which to measure planogram operational component performance, namely a figure-of-merit (i.e., a quantity based on one or more planogram operational component characteristics that represents a measure of efficiency/effectiveness). The figure-of-merit may entail different types of data. One example may include currency sales per SKU per day per store. Another figure-of-merit example may include unit sales per SKU per day per store. A different figure-of-merit example may include currency sales per spatial unit (foot, meter, etc.) of shelf space per unit of time (hour, day, week, month, etc.) per store. Yet another figure-of-merit example may be shopping basket size per receipt per store per day. Still another figure-of-merit example may be lost customer sales over varying periods of time and across all SKUs within a store. Other figures-of-merit examples may measure gross profit, granular profit metrics, availability of environmentally-friendly SKUs, combinations of sales and profit metrics, supply chain and/or fulfillment metrics, and the like. The figure-of-merit may factor into measures like the cost of employee time making planogram changes and/or the cost of lost customer purchases, by way of non-limiting examples. In this embodiment, the objective is to define the figure-of-merit that best captures the desired business goals in a way that enables the measurement of planogram changes in the context of those goals.

At block 702, uncertainty factors may be identified. Retailers, for example, have long-established practices and procedures for designing planograms, but many of the planogram decisions are made amid uncertainty. In some embodiments, subject matter experts may or may not be aware of this uncertainty. There may be uncertainty at a macro level, such as (i) what the overall structure and layout of the planogram should be and/or (ii) on which shelf core SKUs with many facings should be placed. There may also be uncertainty at a micro level, such as (i) which SKUs should be next to each other and/or (ii) how many facings of each product should be offered. Identifying uncertainty can be important in embodiments, as this is where optimization opportunities may lie.

At block 704, constraints and normative operational data may be identified. In this embodiment, a business may impose various constraints on the planogram design. One non-limiting example of a constraint may pertain to which SKUs must or must not be on the same shelf. Another constraint example may pertain to which SKUs must or must not be next to each other. Another constraint example may pertain to the minimum and/or maximum number of facings allowed for each product. Another constraint example may pertain to SKUs that cannot be altered in any way. Another constraint example pertains to whether a shelf layout may be altered in any way, such as increasing a shelf height from 10 inches to 12 inches. As discussed herein, it is important to differentiate between “hard” constraints that cannot be violated and normative operational practices (i.e., “soft” constraints). The latter are conventions that can be changed or stretched, even if they might be very strong conventions. It is preferable to avoid hard constraints in favor of normative operational conventions whenever possible. In some embodiments, constraints may be collected into a lookup table consisting of what is allowed and not allowed.

In this embodiment regarding planograms, constraints (once identified) may be managed in two primary ways. In the first way, subject matter experts (such as human operators of the planogram operational component) may entirely manage the identification and honoring of constraints outside of the system proper. This may be accomplished via subject matter experts carefully specifying the independent variables (which are further discussed herein) in ways that honor the required constraints. In this embodiment, the planogram operational component does not have to know explicitly about the constraints. In the second way, constraints may be codified into the planogram operational component such that it can enforce those rules. Configuring the planogram operational component with those constraints may be accomplished through different examples, such that any suitable combination of such examples may be utilized in various embodiments. In one example, a user can manually enter each constraint in explicit form. In a different example, using any suitable algorithm, the planogram operational component might generate options for planogram changes and have those confirmed or denied by the user. In yet another example, the planogram operational component might analyze past planogram configurations to infer constraints.

At block 706, the temporal extent for changes may be identified. When changes are made to a planogram, it may take time for the impact of such changes to be measurable within the business results. Before implementation of the changes, it may be important to estimate the minimum/maximum time required to measure both business results and time to complete the change. These ranges may be different for large, macro planogram changes as compared to small, micro changes.

At block 708, the spatial extent for changes may be identified. This may include, for example, the distribution of customer visible inventory space to multiple areas within a store. In embodiments, spatial spillover may happen when the business impacts of actions taken in one spatial region bleed over into adjacent spatial regions. For example, customers may visit multiple areas within a store, such that the effects may not be limited to a single location within a store. Spatial reach may be used to account for this by estimating how far in space effects will be measurable in terms of optimization goals. Put another way, this may represent an extent to which changes in one portion of a planogram may impact or spillover into optimization goals measured in a different portion of the planogram or at other locations in the same store.

At block 710, optimization opportunities based on spatial relationships may be identified as between SKUs at a same store or among different stores. For example, changing the spatial relationship between two SKUs, such as by moving one of the SKUs closer/farther with respect to the other product, may impact sales and other components as utilized, for example, by the assortment optimization and customer substitution estimation components discussed herein. By way of non-limiting example, a spatial reach factor may be considered as the region in which a customer will likely take action after encountering a product. An expected region may be based on raw distances (such as a certain radius around the point at which a product is located/encountered) from another product, the degree of connectedness between different regions in a store based on multi-product purchase patterns, or other data that is indicative of the likely regions in which users will act in response to that product. It should be noted that the operations at blocks 708 and 710 may be performed simultaneously or in any suitable order.

At block 712, hypotheses may be formulated and independent variables defined. In embodiments, given uncertainty factors, constraints, and normative operational data, it is possible to formulate hypotheses and define independent variables. In this embodiment, independent variables are those factors and options that can be manipulated to optimize the figure-of-merit. Hypotheses may drive the discovery of causal knowledge leading to optimization and improved performance. Depending on how the constraints are managed, as described herein, hypotheses and independent variables may be entirely defined by subject matter experts, formulated by the planogram operational component itself, or a combination thereof. The definition of independent variables can lead to a large search space for experimentation that is prohibitive with respect to full exploration. In this case, hypotheses can be refined and prioritized through various ways, such as based on subject matter expert knowledge and judgment, or descriptive data analysis. Another way hypotheses can be refined and prioritized is through customer substitution behaviors, as discussed herein with respect to the substitution operational component to drive richer customer substitution behavior knowledge. Another way hypotheses can be refined and prioritized is through purchase pattern behaviors as discussed herein with respect to the multi-item purchase patterns operational component to drive richer purchase pattern behavior knowledge. Another way hypotheses can be refined and prioritized is through out-of-stock operational component. Another way hypotheses can be refined and prioritized is through product location operational component. These hypothesis refinement methods may include a human-in-the-loop in some embodiments, while other embodiments do not utilize human-in-the-loop.

Independent variables may be of different types, such as by way of non-limiting examples, categorical (product on the left side or right side of the planogram), ordinal (first, second, or third shelf), interval (quantity of facings for a product), and/or ratio (relative ratio of facings for each product). In embodiments, it may be most beneficial to define independent variables with independent variable levels that cover a wide range of the possible search space, rather than independent variable levels that only vary in subtle ways. This may create more space for optimization but can also lead to unconventional planograms. In this case, initial application of independent variable levels can be weighted based on normative operational data.

In some embodiments, it may also be highly beneficial for independent variables to be orthogonal such that one set of independent variable levels can be applied in any combination with independent variable levels from other independent variables. However, this is not always possible, depending on the constraints. Constraints may restrict certain independent variable levels from appearing in combination together, prevent certain independent variables and independent variable levels from being used with certain planograms, etc. In this embodiment, such constraints should be avoided as much as possible to maximize the broad application of independent variables and independent variable levels. As described herein, these constraints may be managed by the subject matter expert, codified in the planogram operational component, or a mix of both.

Assignment of particular independent variable levels does not automatically result in a valid planogram in this embodiment, as the planogram creation process may be complex. In the worst case in some embodiments, subject matter experts may have to define planograms that account for each possible combination of independent variable levels. Alternatively, depending on the independent variables and independent variable levels involved, the planogram operational component may be able to generate valid planograms for different independent variable levels combinations (such as with the help of third-party tools by way of non-limiting example). A particular combination of independent variable levels may manifest differently for different planograms (for example in a 4 ft vs. 8 ft module). This is acceptable in this embodiment if the essence or meaning of the independent variable level is still preserved.

As an example, the subject matter expert may hypothesize that a core product X (with many facings) should be placed on a middle shelf of the planogram, roughly at eye-level so that product X is easily found. However, the subject matter expert may be (and should be) uncertain about this hypothesis. Perhaps SKUs with many facings are easy to find even when above or below eye-level. Perhaps having other SKUs at eye-level would result in greater overall business results. This hypothesis can be evaluated by defining an independent variable for the placement of product X on different shelves, perhaps: top, middle, and bottom. This independent variable can be implemented orthogonally for different planogram widths at different stores. Different independent variable levels for this independent variable result in a substantial change to the planogram, therefore this is a “macro” independent variable.

As another example, independent variables may be defined for the minimum and maximum number of facings allowed for product X, product Y, etc. by way of non-limiting example, the number of facings could be defined in a continuous fashion (e.g., 0, 1, 2, 3, . . . 10). These independent variables may allow for testing hypotheses as to how many facings are optimal for each product. Implementing these independent variables in practice can be done through small granular changes, such as “increase facings for product X by one and reduce facings for adjacent product Y by one”. This may result in a small change (i.e., a micro change) that can be implemented gradually on a store-by-store basis as the planogram operational component determines it is worthwhile to do so.

At block 714, macro experimentation may be executed. Certain independent variables may require experimentation on a macro level, such as on the order of months, by way of non-limiting example. This may be primarily driven by the effort and cost required to significantly change a planogram in-store, where this level of experimentation may be more centralized and traditional. It may be important to factor in normative operation and best practices, such as by initially favoring certain independent variable levels over others. Experimental units may be formed by allocating stores to time windows. Each experimental unit may be assigned one or more control signals (allocated to certain independent variable levels for macro independent variables) and each control signal may be executed by defining (if necessary) and setting the corresponding planogram. In this non-limiting example, the time durations need to be long enough to measure figure-of-merit impacts and to limit the cost of setting multiple planograms, but otherwise they should be as short as possible.

Multi-objective optimization approaches to explore/exploit management, baseline monitoring, and data inclusion window may be employed, though these may be limited by the longer time durations. Clustering may be of particular interest with planograms. For example, stores may be clustered based on similar characteristics (e.g., sales and socio-demographics, or SKU out of stock propensities) and to thus create different planograms for different clusters. This clustering may be implemented as part of macro experimentation by pre-initializing the planogram operational component with those clusters and assigning independent variables differently for different clusters. In addition, stores may be completely segmented from each other into essentially independent experiments, although this may greatly limit statistical power in some embodiments.

At block 716, adaptive micro experimentation may be executed, with real technical and real-world improvements being achieved through adaptive micro experimentation. Traditionally, prescriptive experimentation could be used wherein the different micro independent variables are experimented on in a relatively controlled fashion over time. Prescriptive experimentation, however, can carry two essential drawbacks. First, there may be many micro independent variables resulting in a long time spent exploring the search space. Second, prescriptive experimentation may fail to fully leverage domain knowledge and establish best practices to result in overall good performance.

By contrast, adaptive micro experimentation in this non-limiting example is primarily employed in cases where the existing planogram is demonstrating problems. Problems may include, for example, overstock, understock, out-of-stock, disorganization, etc. In these instances, instead of simply rectifying the problem, opportunity may be taken to experiment. This may result in optimizing the experimentation process to instances where problems appear and can help to naturally avoid experimentation in strongly-performing areas of the planogram where there is less room for improvement. In addition to specific problem instances, the planogram operational component can also probabilistically experiment in general—during normal planogram operational component operations—to explore other areas of the search space.

In this embodiment, adaptive micro experimentation is smaller scale and more customized. The planogram changes executed are therefore typically small and quick to implement. Also, changes may typically be implemented organically in a few stores at a time rather than being executed in a coordinated fashion across, for example, hundreds or thousands of stores. Over time, small planogram changes that create demonstrated business value across stores may be implemented broadly. However, many planogram changes might become idiosyncratic to small groups of stores. In this way, the planogram operational component may naturally explore the search space and settle on both global and local optimums.

Experimental units may be defined on the order of day, weeks, or any suitable time units. Independent variables and independent variable levels must be placed in a situational context in this embodiment. For example, if product X is out-of-stock, in regards to which independent variables and independent variable levels can be executed in response, the planogram operational component may look for multiple instances of product X being out-of-stock at different stores, form experimental units for each store, and experiment on different responses to the situation. Similarly, the planogram operational component can sometimes delay control signal application of independent variables and independent variable levels for a time to compare behavior within a store (while also allowing for time to implement the change). In some embodiments, it might be difficult or impossible for all possible situational independent variable/independent variable level response options to be defined in advance. It would be perfectly acceptable in embodiments to define these as they are encountered. In many embodiments, this may be a manual process, but it is feasible and compatible with the planogram operational component to automate when possible. Again, multi-objective optimization approaches for explore/exploit management, baseline monitoring, and data inclusion window, and clustering may be employed for planogram adaptive micro experimentation. Thus, with adaptive micro experimentation in the context of planograms, the benefits are more rapid due to shorter time frames and less substantial planogram changes.

As with the other operational components described herein, the planogram operational component may interface with those other operational components. For example, the out-of-stock operational component may provide a prioritized queue of actions for store associates as it relates to fixing out-of-stocks and where to fix them. The planogram operational component may describe experiment logic for deciding which planogram out-of-stocks to fix vs not fix for specific SKUs. Then the planogram operational component may use the delta of the business results of fixed vs not fixed as a mechanism to isolate causal effects of having vs not having a SKU in a planogram. In some embodiments, this may be treated as queue optimization being executed within a planogram for fixing or not fixing a SKU. This also may be a part of a broader queue optimization process in some embodiments, where whether a SKU is located in a planogram (or somewhere else in a store) is fixed. In some embodiments, queue optimization may integrate into this planogram operational component by exploring which out-of-stock SKUs should be replenished and which SKUs should remain out-of-stock as a function of their planogram configuration. This can, in turn, may provide control over the experimental units used to find optimal planograms and allow optimal planograms to contribute to better product availability decisions by prioritizing specific product out-of-stocks to be fixed. Thus, multiple operational components may contribute to the prioritization of which out-of-stock SKUs should be replenished, and the recommendation based on planogram optimization may not exclusively determine what action (e.g., replenish or not) is taken.

The planogram operational component may also interface with the multi-product purchase patterns operational component, which describes strategies to estimate the probabilities of customers buying specific SKUs together as discussed herein. More specifically, SKU Purchase patterns may systematically be provided as an input into the overall planogram assortment of specific SKUs and as a feedback loop to purchase pattern probability estimates. For example, SKUs commonly purchased together can be moved within their respective planograms to test whether the purchase pattern is sensitive to the amount of visible inventory capacity and relative product placement. In some embodiments, multiple operational components may contribute to the identification of optimal planograms, thus purchase patterns may not drive this exclusively.

The planogram operational component may also interface with the in-store product location operational component, which may provide mechanisms for optimizing where to place SKUs in a store (specific aisles, endcaps, temporary or permanent displays, etc.) based on the measured impact in business terms using causal inference and knowledge. These causal inferences from product location knowledge may be used in the overall optimization of the planogram as it relates to where a specific SKU may be located in the store and its overall impact to business results. For example, if a specific SKU has better business results in an endcap compared to a location in an aisle, less space may be allocated in the aisle planogram for this SKU so that another SKU that performs better in the planogram can have more visible inventory space. Multiple operational components may contribute to the identification of optimal planograms and optimizing product location may not drive this exclusively. Rather, these two operational components may be configured to work closely together because offering a product in a new location and/or removing a product from an existing location may require a planogram change.

The planogram operational component may also interface with the assortment operational component based on measured impact in business terms using causal inference and knowledge. The assortment operational component may specify the set of SKUs to offer for sale at a specific store or website, and therefore constrain the SKUs among which planogram optimization is executed. The planogram operational component may also interface with the customer substitution operational component, which may estimate the probabilities of customers substituting specific SKUs for other SKUs. These estimates may be systematically input into the overall planogram. Substitution probabilities may be one of the principal drivers of planogram optimization, and changes to planograms to reach more optimal configurations may likely affect customer substitution preferences.

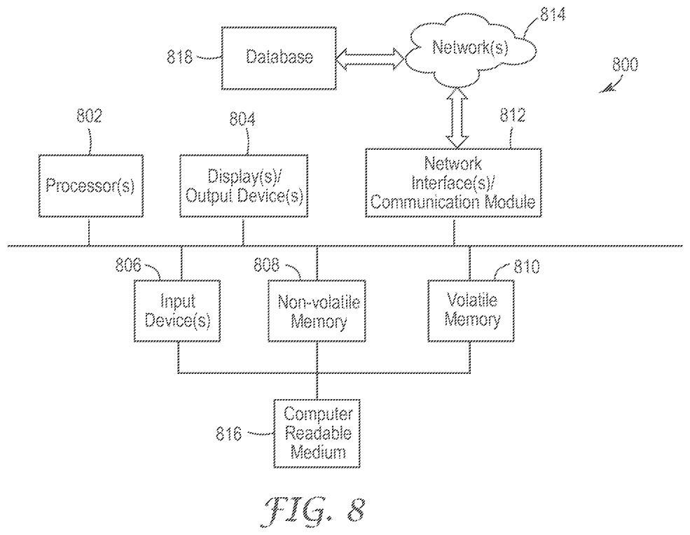

Turning now to FIG. 8, a block diagram illustrates computing hardware, such as an exemplary computing device 800, through which embodiments of the disclosure can be implemented. The computing device 800 described herein is but one example of a suitable computing device and does not suggest any limitation on the scope of any embodiments presented. Nothing illustrated or described with respect to the computing device 800 should be interpreted as being required or as creating any type of dependency with respect to any element or plurality of elements. In various embodiments, the computing device 800 may include, but need not be limited to, a desktop, laptop, server, client, tablet, smartphone, computing cloud or any other type of device that can utilize data. In an embodiment, the computing device 800 includes at least one processor 802 and memory comprising non-volatile memory 808 and/or volatile memory 810. The computing device 800 can include one or more displays and/or output devices 804 such as, for example, monitors, speakers, headphones, projectors, wearable-displays, holographic displays, and/or printers. Output devices 804 may further include, for example, displays and/or speakers, devices that emit energy (radio, microwave, infrared, visible light, ultraviolet, x-ray and gamma ray), electronic output devices (Wi-Fi, radar, laser, etc.), audio (of any frequency), and the like.

The computing device 800 may further include one or more input devices 806 which can include, by way of example, any type of mouse, keyboard, disk/media drive, memory stick/thumb-drive, memory card, pen, touch-input device, biometric scanner, voice/auditory input device, motion-detector, camera, scale, and any device capable of measuring data such as motion data (e.g., an accelerometer, GPS, a magnetometer, a gyroscope, etc.), biometric data (e.g., blood pressure, pulse, heart rate, perspiration, temperature, voice, facial-recognition, motion/gesture tracking, gaze tracking, iris or other types of eye recognition, hand geometry, oxygen saturation, glucose level, fingerprint, DNA, dental records, weight, or any other suitable type of biometric data, etc.), video/still images, and audio (including human-audible and human-inaudible ultrasonic sound waves). Input devices 806 may include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 800 typically includes non-volatile memory 808 (e.g., ROM, flash memory, etc.), volatile memory 810 (e.g., RAM, etc.), or a combination thereof. A network interface 812 can facilitate communications over a network 814 with other data source such as a database 818 via wires, a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks may include, but are not limited to, technologies such as LTE, WiMAX, UMTS, CDMA, and GSM. Network interface 812 can be communicatively coupled to any device capable of transmitting and/or receiving data via one or more network(s) 814. Accordingly, the network interface 812 can include a communication transceiver for sending and/or receiving any wired or wireless communication. For example, the network interface 812 may include an antenna, a modem, LAN port, Wi-Fi card, WiMax card, mobile communications hardware, near-field communication hardware, satellite communication hardware and/or any wired or wireless hardware for communicating with other networks and/or devices.

A computer-readable medium 816 comprises one or more plurality of computer readable mediums, each of which is non-transitory. A computer readable medium may reside, for example, within an input device 806, non-volatile memory 808, volatile memory 810, or any combination thereof. A readable storage medium can include tangible media that is able to store instructions associated with, or used by, a device or system. A computer readable medium, also referred to herein as a non-transitory computer readable medium, includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A non-transitory computer readable medium may also include, for example, a system or device that is of a magnetic, optical, semiconductor, or electronic type. A non-transitory computer readable medium excludes carrier waves and/or propagated signals taking any number of forms such as optical, electromagnetic, or combinations thereof.

The computing device 800 may include one or more network interfaces 812 to facilitate communication with one or more remote devices, which may include, for example, client and/or server devices. The network interface 812 may also be described as a communications module, as these terms may be used interchangeably. The database 818 is depicted as being accessible over the network 814 and may reside within a server, the cloud, or any other configuration to support being able to remotely access data and store data in the database 818.

All references, patents, and patent applications referenced in the foregoing are hereby incorporated by reference in their entirety in a consistent manner. In the event of inconsistencies or contradictions between portions of the incorporated references and this application, the information in the preceding description shall control.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. The application is intended to cover any adaptations or variations of the specific embodiments discussed herein.

1. A method comprising:
selecting a plurality of operational components to which operational resources are allocated;
selecting a plurality of control signals for the plurality of operational components;
applying the plurality of control signals to the plurality of operational components to determine an operational effect of the plurality control signals on the operational components;
applying a resource requirement for each of the plurality of operational components;
determining, using a queue optimization model, a first control signal target value, based on the operational effect of each of the plurality of control signals on each of the plurality of operational components and the resource requirement for each of the plurality of control signals for each of the plurality of operational components; and
assigning, based on the first control signal target value, an operational resource allocation to each of the plurality of operational components.

2. (canceled)

3. The method of claim 1, further comprising ensuring that a subsequent operational component adheres to a limitation from another operational component wherein the limitation is a constraint that defines a parameter for control signals that are allowed or not allowed, wherein control signals assign operational resource allocations.

4.-6. (canceled)

7. The method of claim 1, wherein the plurality of operational components comprises two or more of the following: out-of-stock, assortment, product location, planogram, substitution, and multi-item purchase patterns, wherein one of the operational components is the out-of-stock operational component comprising simultaneously:
prioritizing fixing of out-of-stock identifier instances;
utilizing instances of fixing out-of-stock to use controlled experimentation to assess a substitution probability for a user to substitute a given identifier or collection of identifiers for other identifiers;
providing results of the controlled experimentation recursively into a continuously updated out-of-stock fixing prioritization process; and
providing the results to recommendation and operational systems for continuous improvement in product assortments at multiple retail locations.

8. The method of claim 7, further comprising determining a substitution probability by comparing the actual sales of other products when a subject product is unavailable to the expected sales of other products over the same time periods the subject product was available.

9. The method of claim 8, further comprising:
determining an estimated substitution matrix;
determining, based on the substitution matrix, the relative value of offering and not offering each product; and
providing a recommendation for an assortment change based upon the determined relative value of offering and not offering a product.

10. The method of claim 7, wherein one of the operational components is the assortment optimization operational component which determines the optimal mix of available products for each store by comparing a value of an item being in a store versus a value of the item not being in the store.

11. The method of claim 10, wherein determining the optimal mix of available products for each store further comprises a continuous, integrated, adaptive clinical trial that automatically adjusts to changes in real-time.

12.-61. (canceled)

62. At least one system comprising:
at least one computing device comprising one or more processors; and
at least one memory coupled to at least one of the one or more processors, wherein the at least one memory comprises instructions that configure the at least one computing device to:
select a plurality of operational components to which operational resources are allocated;
select a plurality of control signals for the plurality of operational components;
apply each of the plurality of control signals to each of the plurality of operational components to determine an operational effect of each of the plurality control signals on each of the plurality of operational components;
apply a resource requirement for each of the plurality of operational components;
determine, using a queue optimization model, a first control signal target value, based on the operational effect of each of the plurality of control signals on each of the plurality of operational components and the resource requirement for each of the plurality of control signals for each of the plurality of operational components; and
assign, based on the first control signal target value, an operational resource allocation to each of the plurality of operational components.

63. (canceled)

64. The at least one system of claim 62, wherein the at least one computing device is further configured to ensure that a subsequent operational component adheres to a limitation from another operational component, wherein the limitation is a constraint that defines a parameter for control signals that are allowed or not allowed, wherein control signals assign operational resource allocations.

65.-67. (canceled)

68. The at least one system of claim 62, wherein the plurality of operational components comprises two or more of the following: out-of-stock, assortment, product location, planogram, substitution, and multi-item purchase patterns, wherein one of the operational components is the out-of-stock operational component comprising simultaneously:
prioritizing fixing of out-of-stock identifier instances;
utilizing instances of fixing out-of-stock to use controlled experimentation to assess a substitution probability for a user to substitute a given identifier or collection of identifiers for other identifiers;
providing results of the controlled experimentation recursively into a continuously updated out-of-stock fixing prioritization process; and
providing the results to recommendation and operational systems for continuous improvement in product assortments at multiple retail locations.

69. The computing device of claim 68, wherein the processor is further configured to determine a substitution probability by comparing the actual sales of other products when a subject product is unavailable to the expected sales of other products over the same time periods the subject product was available.

70. The computing device of claim 69, wherein the processor is further configured to:
determine an estimated substitution matrix;
determine, based on the substitution matrix, the relative value of offering and not offering each product; and
provide a recommendation for an assortment change based upon the determined relative value of offering and not offering a product.

71. The computing device of claim 68, wherein one of the operational components is the assortment optimization operational component which determines the optimal mix of available products for each store by comparing a value of an item being in a store versus a value of the item not being in the store.

72. The computing device of claim 71, wherein determining the optimal mix of available products for each store further comprises a continuous, integrated, adaptive clinical trial that automatically adjusts to changes in real-time.

73.-122. (canceled)

123. One or more non-transitory computer-readable storage media encoded with instructions that, when executed, configure processing circuitry of a computing device for:
selecting a plurality of operational components to which operational resources are allocated;
selecting a plurality of control signals for the plurality of operational components;
applying each of the plurality of control signals to each of the plurality of operational components to determine an operational effect of each of the plurality control signals on each of the plurality of operational components;
applying a resource requirement for each of the plurality of operational components;
determining, using a queue optimization model, a first control signal target value, based on the operational effect of each of the plurality of control signals on each of the plurality of operational components and the resource requirement for each of the plurality of control signals for each of the plurality of operational components; and
assigning, based on the first control signal target value, an operational resource allocation to each of the plurality of operational components.

124. (canceled)

125. The one or more non-transitory computer-readable storage media of claim 123, further comprising instructions for ensuring that a subsequent operational component adheres to a limitation from another operational component, wherein the limitation is a constraint that defines a parameter for control signals that are allowed or not allowed, wherein control signals assign operational resource allocations.

126.-128. (canceled)

129. The one or more non-transitory computer-readable storage media of claim 123, wherein the plurality of operational components comprises two or more of the following: out-of-stock, assortment, product location, planogram, substitution, and multi-item purchase patterns, wherein one of the operational components is the out-of-stock operational component comprising simultaneously:
prioritizing fixing of out-of-stock identifier instances;
utilizing instances of fixing out-of-stock to use controlled experimentation to assess a substitution probability for a user to substitute a given identifier or collection of identifiers for other identifiers;
providing results of the controlled experimentation recursively into a continuously updated out-of-stock fixing prioritization process; and
providing the results to recommendation and operational systems for continuous improvement in product assortments at multiple retail locations.

130. The one or more non-transitory computer-readable storage media of claim 129, further comprising instructions for determining a substitution probability by comparing the actual sales of other products when a subject product is unavailable to the expected sales of other products over the same time periods the subject product was available.

131. The one or more non-transitory computer-readable storage media of claim 130, further comprising instructions for:
determining an estimated substitution matrix;
determining, based on the substitution matrix, the relative value of offering and not offering each product; and
providing a recommendation for an assortment change based upon the determined relative value of offering and not offering a product.

132. The one or more non-transitory computer-readable storage media of claim 129, wherein one of the operational components is the assortment optimization operational component which determines the optimal mix of available products for each store by comparing a value of an item being in a store versus a value of the item not being in the store.

133.-183. (canceled)
